(19) United States
(12) Patent Application Publication
(10) Pub. No.: US 2024/0015052 A1
(43) Pub. Date: Jan. 11, 2024

(54) COMMUNICATION DEVICE, COMMUNICATION METHOD, AND COMMUNICATION SYSTEM

(71) Applicant: SONY GROUP CORPORATION, TOKYO (JP)

(72) Inventors: HIROMASA UCHIYAMA, TOKYO (JP); SHINICHIRO TSUDA, TOKYO (JP)

(21) Appl. No.: 18/257,881

(22) PCT Filed: Dec. 10, 2021
(86) PCT No.: PCT/JP2021/045511

§ 371 Date: Jun. 16, 2023

(30) Foreign Application Priority Data
Dec. 23, 2020 (JP) 2020-213902
Mar. 22, 2021 (JP) 2021-047806

(51) Int. Cl. H04L 25/02; H04W 28/20

(52) U.S. Cl. CPC H04L 25/0254; H04W 28/20

(57) ABSTRACT

[Problem] To provide an information processing device and the like for causing an application that executes calculation based on a DNN to comfortably operate in a communication environment by using distributed learning.

[Solution] One information processing device according to the present disclosure receives information regarding resources of a communication network that relays communication between a communication terminal that transits an input to a deep neural network or is in charge of at least a part of a series of calculation of the deep neural network and transmits a result of the calculation and a server that is able to be in charge of at least a part of the series of calculation, and determines an entity to which the series of calculation is assigned from among the communication terminal, the server, and the communication node in the communication network on the basis of the information regarding the resources.

### TECHNICAL FIELD

The present disclosure relates to a communication device, a communication method, and a communication system.

### BACKGROUND ART

In recent years, research in the fields of artificial intelligence and machine learning has rapidly advanced, and related applications are expected to be rapidly distributed. Therefore, studies on making the applications operate comfortably in communication environments have been carried out.

The applications involve performing calculation mainly on the basis of neural networks (deep neural networks: DNN) including a plurality of layers with internal parameters optimized by machine learning. This calculation requires larger loads than other typical applications. Therefore, if the applications are executed by general-purpose wireless communication terminals such as smartphones, then problems such as increases in calculation time and power consumption occur. On the other hand, a method in which a cloud server performs the calculation instead is also conceivable. However, according to this method, the wireless communication terminals transmit information necessary for the calculation to the cloud server and receive calculation results from the cloud server, and the amounts of communication thus increase. Furthermore, in the case of wireless communication, communication quality is unstable, and delay is thus likely to occur. Therefore, there is a concern that the amount of delay allowable for these applications may be exceeded according to these methods.

Thus, distributed learning of distributing calculation of the DNN to both the communication terminals and the cloud server instead of federated learning of centralizing the calculation of the DNN to the communication terminals, the cloud server, or the like has been studied. In other words, causing the communication terminals to be in charge of a part of the calculation of the DNN and causing the cloud server to be in charge of the remainder of the calculation of the DNN has been studied.

### CITATION LIST

### Non Patent Literature

[NPL 1]
3rd Generation Partnership Project (3GPP), “Technical Report (TR) 22.874, V0.1.0, Study on traffic characteristics and performance requirements for AI/ML model transfer” (Chapter 5: Split AI/ML operation between AI/ML endpoints), URL: https://portal.3gpp.org/desktopmodules/Specifications/SpecificationDetails.aspx?specificationId=3721

### SUMMARY

### Technical Problem

Furthermore, assigning a part of the calculation of the DNN to a communication network that relays communication between the communication terminals and the cloud server has also been studied. In other words, at least any of a plurality of communication nodes configuring the communication network can be in charge of a part of the calculation of the DNN. However, in this case, which of the communication nodes is in charge of the calculation is a key, and conditions may deteriorate depending on selection of the communication node.

Since the communication nodes are closer to the communication terminals than the cloud server, communication times are expected to become shorter than those in a case where the communication nodes are not in charge of a part of the calculation of the DNN. However, in a case where a communication node connected to a communication link with poor communication quality is in charge of the calculation, the communication time may not become shorter than expected. Also, calculation capabilities of the communication nodes are assumed to be lower than that of the cloud server, and there is a concern that the calculation times of the communication nodes may increase and the total time may even increase as compared with a case where the communication nodes are not in charge of a part of the calculation of the DNN.

Thus, the present disclosure provides an information processing device and the like for causing an application that executes calculation based on a DNN to comfortably operate in a communication environment by using distributed learning.

### Solution to Problem

One information processing device according to the present disclosure receives information regarding resources of a communication network that relays communication between a communication terminal that transmits an input to a deep neural network or is in charge of at least a part of a series of calculation of the deep neural network and transmits a result of the calculation and a server that is able to be in charge of at least a part of the series of calculation, and determines an entity to which the series of calculation is assigned from among the communication terminal, the server, and communication nodes in the communication network on the basis of the information regarding the resources.

Also, the information processing device may determine at least one of the communication nodes as the component that is in charge of the calculation.

Additionally, the information processing device may determine a calculation range of which the component that is in charge of the calculation is in charge on the basis of the information regarding the resources.

Moreover, the information processing device may determine at least one of the communication nodes that are present on a communication route between the communication terminal and the server as the component that is in charge of the calculation.

Also, the resources may include communication capacity or communication quality of a communication link in the communication network, and the information processing device may determine at least one of the communication nodes as the component that is in charge of the calculation on the basis of the communication capacity or the communication quality.

Also, the information processing device may estimate communication times in which results of calculation performed by the communication nodes are transmitted via the communication link on the basis of the communication capacity or the communication quality and determine at least one of the communication nodes as the component that is in charge of the calculation on the basis of the communication times.

Additionally, the resources may include spare calculation capacity of the communication nodes, and the information processing device may determine at least one of the communication nodes as the component that is in charge of the calculation on the basis of the spare calculation capacity of the communication nodes.

Moreover, the information processing device may estimate calculation times required by the communication nodes to perform calculation on the basis of the spare calculation capacity of the communication nodes and determine at least one of the communication nodes as the component that is in charge of the calculation on the basis of the calculation times.

Also, the resources may include communication capacity or communication quality of the communication link in the communication network and spare calculation capacity of the communication nodes, and the information processing device may estimate communication times in which results of the calculation performed by the communication nodes are transmitted via the communication link on the basis of the communication capacity or the communication quality estimate calculation times required by the communication nodes to perform the calculation on the basis of the spare calculation capacity of the communication nodes, and determine at least one of the communication nodes as the component that is in charge of the calculation on the basis of a condition that the sum of the communication time and the calculation time does not exceed a predetermined threshold value.

Also, the information processing device may further receive information regarding the position of the communication terminal and change the component that is in charge of the calculation in accordance with a change in the communication route accompanying movement of the communication terminal.

Also, the information processing device may further receive information regarding a topology of the communication network and change the component that is in charge of the calculation in accordance with a change in the communication route accompanying a change in the topology.

Also, the information processing device may determine a calculation range of which the entity with the calculation assigned thereto is in charge by the component that is in charge of the calculation selecting one of proposed assignments, for which calculation ranges scheduled to be assigned are indicated, on the basis of the resources.

Also, the resources may include the position of the communication terminal, and the information processing device may recreate the proposed assignments when there is no predetermined communication node on the communication route changed by movement of the communication terminal.

Also, the information processing device may change the calculation range of which the component that is in charge of the calculation is in charge by increasing or decreasing the calculation range of which the component that is in charge of the calculation is in charge on the basis of variations in the resources.

Additionally, the information processing device may transmit the calculation range to the communication node that has been determined as the component that is in charge of the calculation.

Moreover, the information processing device may determine a setting value for improving quality of a wireless communication link on the communication route and transmit the setting value for improving the quality of the wireless communication link on the communication route to the communication nodes that are present on the communication route.

Also, another information processing device according to the present disclosure receives a part of a series of calculation based on a deep neural network as an assigned calculation range, performs calculation of the calculation range, transmits a result of the calculation of the calculation range to a designated destination, acquires information regarding spare calculation capacity or communication capacity or communication quality of a communication link through which the calculation result is transmitted, transmits the acquired information to a designation source of the calculation range, and receives a change in the calculation range from the designation source.

Also, another information processing device described above may transmit the calculation result to a final reception destination of the calculation result of the series of calculation rather than the designated destination in a case where the calculation result satisfies a condition for ending the series of calculation in the middle.

Additionally, the information regarding a change in the calculation range may be information indicating one of a plurality of splitting modes.

An information processing method according to another aspect of the present disclosure includes the steps of: receiving information regarding resources of a communication network that relays communication between a communication terminal that transmits an input to a deep neural network or is in charge of at least a part of a series of calculation of the deep neural network and transmits a result of the calculation and a server that is able to be in charge of at least a part of the series of calculation; and determining a plurality of entities to which the series of calculation is assigned from among the communication terminal, the server, and communication nodes in the communication network on the basis of the information regarding the resources.

A communication system according to another aspect of the present disclosure includes: a plurality of communication nodes that belong to a communication network that relays communication between a communication terminal that transmits an input to a deep neural network or is in charge of at least a part of a series of calculation of the deep neural network and transmits a result of the calculation and a server that is able to be in charge of at least a part of the series of calculation, in which the plurality of communication nodes transmit information regarding resources of the communication network to a predetermined communication node from among the plurality of communication nodes, and the predetermined communication node receives the information regarding the resources, and determines a plurality of entities to which the series of calculation is assigned from among the communication terminal, the server, and the communication nodes on the basis of the information regarding the resources.

Another information processing method according to the present disclosure includes the steps of determining a first assignment range of a series of calculation of a deep neural network; executing calculation of the first assignment range; transmitting first information including identification information and an output value of a node included in a final layer in the first assignment range as a result of the calculation of the first assignment range; receiving the first information; identifying a node to which the output value included in the first information is to be input on the basis of the identification information included in the first information; and executing remaining calculation of the deep neural network or calculation of a second assignment range by inputting the output value included in the first information to the identified node.

Also, another information processing method described above may further include the step of replying with a result of the remaining calculation of the deep neural network or the calculation of the second assignment range to a transmission source of the calculation result of the first assignment range.

Additionally, another information processing method described above may further include the step of receiving conditions for determining the first assignment range, and the first assignment range may be determined on the basis of the conditions.

The conditions in another information processing method described above may include a condition related to spare calculation capacity of an entity to calculate the first assignment range.

The conditions in another information processing method described above may include a condition related to communication quality between an entity to calculate the first assignment range and a predetermined entity.

The communication quality in another information processing method described above may be calculated on the basis of at least one of a delay time, a data rate, and a channel occupancy ratio.

In another information processing method described above, an entity to execute the remaining calculation of the deep neural network or the calculation of the second assignment range and an entity to transmit the conditions for determining the first assignment range may be different from each other.

Yet another third information processing device according to the present disclosure executes an application using a deep neural network, determines a first assignment range of a series of calculation of the deep neural network on the basis of conditions for determining the first assignment range, executes calculation of the first assignment range, and transmits first information including identification information and an output value of a node included in a final layer in the first assignment range as a result of the calculation of the first assignment range.

The third information processing device may transmit the first information to an entity that performs the series of calculation of the deep neural network next and receive a result of remaining calculation of the deep neural network or calculation of a second assignment range as a reply to the first information.

The conditions that the third information processing device uses include a condition related to spare calculation capacity of the information processing device itself, and the first assignment range may be determined in accordance with the spare calculation capacity.

The conditions that the third information processing device uses may include a condition related to communication quality between the information processing device itself and a predetermined entity, and the first assignment range may be determined in accordance with the communication quality.

The communication quality that is the condition used by the third information processing device may be calculated on the basis of at least one of a delay time, a data rate, and a channel occupancy ratio.

Yet another fourth information processing device according to the present disclosure receives first information including identification information and an output value of a node included in a final layer in a first assignment range of a series of calculation of a deep neural network as a result of calculation of the first assignment range, identifies a node to which the output value included in the first information is to be input on the basis of the identification information included in the first information, and executes remaining calculation of the deep neural network or calculation of a second assignment range by inputting the output value included in the first information to the identified node.

The fourth information processing device may reply with a result of the remaining calculation of the deep neural network or the calculation of the second assignment range to a transmission source of the calculation result of the first assignment range.

The second assignment range of the fourth information processing device may be determined on the basis of conditions for determining the second assignment range, and the conditions used by the fourth information processing device may include a condition related to spare calculation capacity of the information processing device itself.

The second assignment range of the fourth information processing device may be determined on the basis of conditions for determining the second assignment range, and the conditions used by the fourth information processing device may include a condition related to communication quality between the information processing device itself and a predetermined entity.

The communication quality that is the condition used by the fourth information processing device may be calculated on the basis of at least one of a delay time, a data rate, and a channel occupancy ratio.

### BRIEF DESCRIPTION OF DRAWINGS

FIG. 1 is a diagram illustrating a configuration example of an information processing system according to an embodiment of the present disclosure.

FIG. 2 is a diagram for explaining a DNN.

FIG. 3 is a diagram for explaining distribution of calculation of the DNN.

FIG. 4 is a diagram for explaining differences in delays and amounts of output data in accordance with splitting points.

FIG. 5 is a diagram illustrating an example of an architecture of an IAB network.

FIG. 6 is a diagram illustrating effects of the distribution of the calculation of the DNN.

FIG. 7 is a diagram of a network topology in the IAB network used in simulation.

FIG. 8 is a diagram illustrating variations in communication capacity for the simulation.

FIG. 9 is a diagram illustrating influences of resources of a communication network on an execution delay.

FIG. 10 is an overview sequence diagram illustrating a flow of overall processing according to the present embodiment.

FIG. 11 is a diagram for explaining a splitting mode.

FIG. 12 is a diagram for explaining a splitting mode set for each communication route.

FIG. 13 is a diagram illustrating an example of the splitting mode for each communication route.

FIG. 14 is a sequence diagram before and after a component that is in charge of calculation is switched.

FIG. 15 is a diagram illustrating an example of conditions for determining an assignment range of a communication terminal.

FIG. 16 is a diagram illustrating an example of a calculation result transmitted from the communication terminal in a case where the communication terminal has determined its own assignment range.

FIG. 17 is an overview sequence diagram illustrating a flow of overall processing in a case where the communication terminal determines its own assignment range.

FIG. 18 is a diagram illustrating a configuration example of a base station device.

FIG. 19 is a diagram illustrating a configuration example of the communication terminal.

FIG. 20 is a diagram illustrating a configuration example of a network architecture of a 5G system (5GS) including a core network.

### DESCRIPTION OF EMBODIMENTS

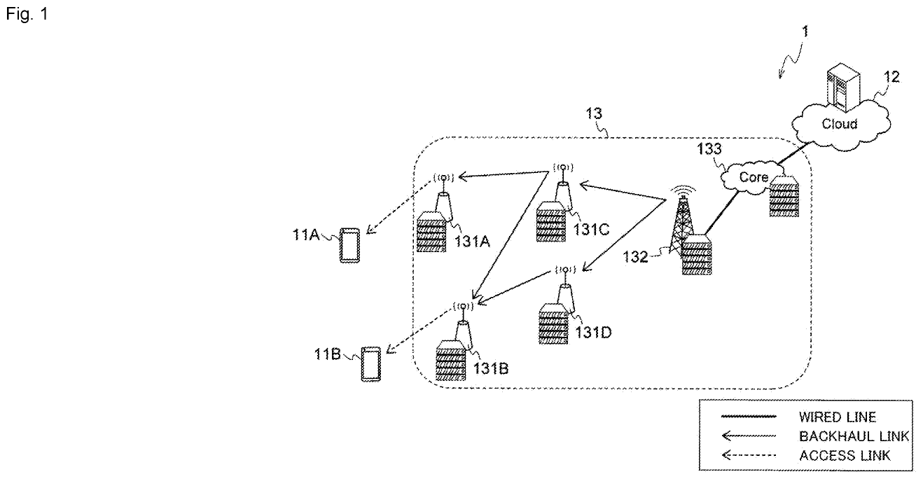

Hereinafter, embodiments of the present disclosure will be described in detail on the basis of the drawings. FIG. 1 is a diagram illustrating a configuration example of an information processing system according to an embodiment of the present disclosure. An information processing system 1 according to the present embodiment includes communication terminals 11, a cloud system (cloud) 12, and a communication network 13. Note that in regard to the reference signs, the same numbers are applied to individuals of the same type and each of the individuals is distinguished by a letter as in 11A and 11B illustrated in FIG. 1. Also, in a case where there is no special need to distinguish the individuals, letters of the reference signs will not be described in the present description.

The information processing system 1 is a system for causing an application using a deep neural network (DNN) leaned by machine learning (ML) to operate. Hereinafter, the application will be referred to as an ML application.

The communication terminals 11 are also information processing devices capable of activating the ML application, and smartphones, laptop computers, and the like correspond thereto. For example, it is assumed that the ML application has been installed on a smartphone and a user of the smartphone activates the ML application. Also, robots, operations of which are controlled by the ML application, also correspond to the communication terminals 11. The cloud system 12 includes one or more information processing devices that are called cloud servers and exhibit higher performance than the communication terminals 11, and provides services that can be used by the communication terminals 11. The communication network 13 is configured of a plurality of communication nodes and relays communication between the communication terminals 11 and the cloud system 12. Note that the communication nodes are also referred to as communication base stations.

Note that FIG. 1 illustrates an example in which the communication network 13 includes a wireless communication network. In the example in FIG. 1, an example using an integrated access and backhaul (IAB) used for wireless communication of a 5-th generation mobile communication system (5G) is illustrated, and the communication terminals 11 are illustrated as wireless communication terminals, and the communication network 13 is configured of wireless communication nodes 131 capable of establishing wireless communication connection with the communication terminals 11, a donor node 132 that is a higher node of the one or more wireless communication nodes 131, and a core network 133 that performs wired communication between the donor node 132 and the cloud system 12. A wireless communication network with less stable communication quality than wired communication is preferably included in the communication network 13 as in FIG. 1 since higher effects, which will be described later, are achieved than those in the related art. However, the entire communication of the information processing system 1 may be wired communication, and the wireless communication network that can be included in the communication network 13 is not limited to the IAB network.

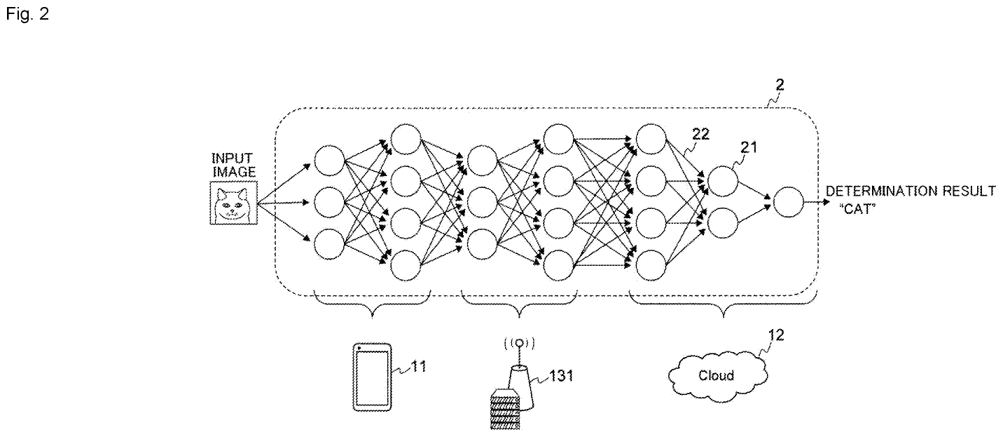

FIG. 2 is a diagram for explaining the DNN. The network surrounded by the dotted line frame 2 in FIG. 2 corresponds to the DNN. The DNN is configured of a plurality of nodes 21 and a link 22 connecting the nodes 21. Also, as illustrated in FIG. 2, the plurality of nodes 21 are divided into node groups vertically aligned in lines, and the node groups are referred to as layers (hierarchies). Although the DNN has seven layers in the example in FIG. 2, the number of layers that the DNN has may be three or more.

Calculation of the DNN is performed by each node 21. In FIG. 2, for example, image information is input to each node 21 of the first layer that is called an input layer, and each node 21 of the first layer performs calculation. The calculation results are sent to each node 21 of a second layer via the link 22, and each node 21 of the second layer also performs calculation. In this manner, calculation is performed from the input layer, and the node of the final layer that is called an output layer outputs a final calculation result. Then, an object appearing in the input image is determined to be a cat on the basis of the output calculation result.

Note that although the example of image recognition is illustrated in FIG. 2, purposes of the ML application are not particularly limited. For example, augmented reality (AR), automatic driving, robotics, sound recognition, and the like in addition to the image recognition can be realized by using the DNN, and the ML application may be related to such purposes.

Smartphones or the like corresponding to the communication terminals 11 typically have lower specs than cloud servers. Therefore, in a case where the communication terminals 11 are caused to perform all parts of processing of the ML application, particularly calculation of the DNN as they are (in device learning), a calculation time until completion becomes long. In other words, a long calculation delay occurs. However, there may be a request to cause the time required to execute the ML application to fall within a predetermined allowable limit depending on the specification of the ML application, and there is a concern that the calculation delay may exceed the allowable limit if the communication terminals 11 are in charge of all the parts of the calculation of the DNN.

On the other hand, in a case where the cloud system 12 rather than the communication terminals 11 is caused to execute the calculation of the DNN (cloud learning), the time required for the communication, in other words, a communication delay becomes problematic. For a rescue robot adapted to search for victims of disaster while performing imaging, for example, cloud servers are caused to perform calculation that excessively consume power to reduce power consumption. However, there is a concern that if it is necessary to send necessary data from the robot to the cloud servers, and a thus caused communication delay increases, the sum of the communication delay and the calculation delay may exceed the allowable limit of the ML application. Additionally, there is also a concern that the data transmission may weight heavily on the band and this may affect other communication as well.

Thus, the information processing system 1 determines a plurality of components that are in charge of the calculation from among the communication terminals 11, the cloud system 12, and the communication network 13 and causes the plurality of components that are in charge of the calculation to process the series of calculation based on the DNN in a distributed manner. Such processing is also referred to as distributed learning. Here, the components that are in charge of the calculation indicate entities that are in charge of at least a part of the calculation of the DNN.

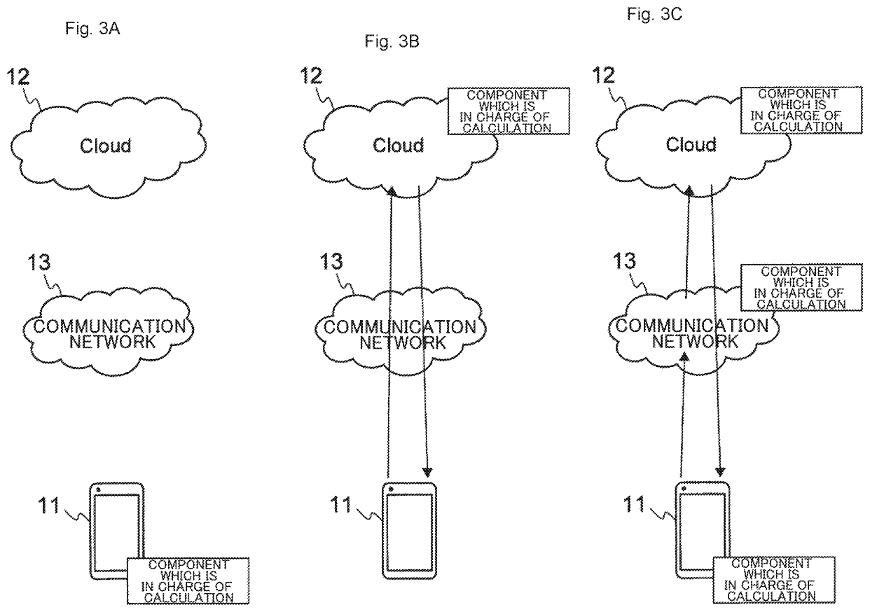

FIG. 3 is a diagram for explaining distribution of the calculation of the DNN. FIGS. 3(A) and 3(B) illustrate examples of federated learning which is not the distributed learning, and FIG. 3(C) illustrates an example of the distributed learning.

In the example in FIG. 3(A), the components that are in charge of the calculation are only the communication terminals 11, and the communication terminals 11 perform the calculation of the DNN (in device learning). Although no communication delay occurs since there is no data transmitted to the communication network 13 as described above, a calculation delay caused by low calculation capability of the communication terminals 11 becomes problematic. On the other hand, only the cloud system 12 performs calculation of the DNN (cloud learning), and the communication terminals 11 transmit information necessary for the calculation to the cloud system 12 and receive calculation results from the cloud system 12 in the example in FIG. 3(B). Although that high calculation capability of the communication terminals 11 is not needed, and this is excellent in terms of the low calculation delay of the cloud system 12, a communication delay between the communication terminals 11 and the cloud system 12 becomes problematic.

On the other hand, each of the communication terminals 11, the cloud system 12, and the communication network 13 is in charge of a part of the calculation of the DNN in the example in FIG. 3(C). In other words, the communication network 13 also provides calculation power to the ML application executed by the communication terminals 11. Since the cloud servers with high calculation capability in the cloud system 12 are in charge of a part of the calculation of the DNN, the calculation delay can be reduced as compared with the case where only the communication terminals 11 perform the calculation of the DNN. Also, in the example in FIG. 3(C), transmission data from the communication terminals 11 is received and processed by the communication network 13 and is then transmitted to the cloud system 12. Since the communication time is reduced if it is possible to reduce the transmission data from the communication network 13 to the cloud system 12 in size as compared with the transmission data from the communication terminals 11, it is possible to reduce the communication delay as compared with the case in FIG. 3(B) in which only the cloud system 12 performs the calculation. Therefore, the sum of the calculation delay that is a time required by each component that is in charge of communication to perform the calculation of the DNN and the communication delay that is a time required by each component that is in charge of communication to communicate information required to perform the calculation of the DNN may be smaller than that in the case of FIG. 3(B).

In this time, the time required to execute the ML application, more specifically, the time until an output from the DNN is obtained after an input to the DNN is performed is caused to fall within a predetermined allowable limit by processing the series of calculation of the DNN in a distributed manner in the present embodiment. Note that the time required to execute the ML application will be described as an execution delay below.

Also, in a case where the communication network 13 is determined to be a component that is in charge of the calculation, one or more communication nodes in the communication network 13 are further determined to be components that are in charge of the calculation. Note that the wireless communication nodes 131 and the donor node 132 described above correspond to the communication nodes. Also, the communication nodes are also present in the core network 133, and the communication nodes in the core network 133 can also be selected as components that are in charge of the calculation.

Although the DNN in FIG. 2 has seven layers, for example, it illustrates that the communication terminals 11 are in charge of the first and second layers, the wireless communication nodes 131 are in charge of the third and fourth layers, and the cloud system 12 is in charge of the fifth to seventh layers. In this case, the communication terminals 11 transmit calculation results of the second layer to the wireless communication nodes 131, the wireless communication nodes 131 perform calculation of the third layer and the fourth layer from the results of the calculation of the second layer, and transmit the calculation results of the fourth layer to the cloud system 12, and the cloud system 12 performs calculation of the fifth layer to the seventh layer from the results of the calculation of the fourth layer. Note that the cloud system 12 may reply with the results of the calculation of the seventh layer to the communication terminal 11, and the communication terminal 11 may determine that the input is an image of a cat on the basis of the results of the calculation of the seventh layer. Alternatively the cloud system 12 may determine that the input is an image of a cat on the basis of the results of the calculation of the seventh layer and reply with the result of the determination to the communication terminal 11.

Note that although there are various types of DNN such as a convolution neural network (CNN), it is assumed that the ML application uses a DNN for which calculation can be assigned to and performed by each layer as described above.

Note that parameters of the DNN may be updated or may not be updated in the present embodiment. In other words, the DNN may have already completed learning, and the parameters of the DNN may not be updated. Alternatively correct answers may be received by users of the communication terminals 11 via the ML application, and learning may be executed on the basis of the correct answers. However, in a case where learning is executed and the DNN is updated, the new updated DNN is distributed to the components that are in charge of the calculation in order to prevent a situation in which the components that are in charge of the calculation use different DNNs.

Note that in a case where communication nodes are determined to be components that are in charge of the calculation, infrastructure for establishing communication in the communication nodes may be caused to execute the calculation in practice. Alternatively a server that executes calculation may be provided in the communication nodes. Note that an information processing device that performs a part of the cloud service instead from a location (also referred to as an edge) that is closer to the user than the cloud service, such as a communication node, is generally referred to as an edge server.

Note that the calculation of the DNN is not necessarily distributed to each of the communication terminals 11, the cloud system 12, and the communication network 13. It is also possible to complete the calculation of the DNN in the communication network 13 without using the cloud system 12 depending on the application. In this case, the total distance of the communication route becomes short, and it is thus possible to further reduce the communication delay. Also, there may also be a case where the communication terminals 11 do not perform the calculation of the DNN and the calculation of the DNN is distributed to the cloud system 12 and the communication network 13. Alternatively in a case where a communication terminal 11 that is connected to the communication network 13 and has high spare calculation capacity is discovered separately from the communication terminals 11 that have executed the ML application, the discovered communication terminal 11 may be caused in charge of the calculation of the DNN after getting consent of the discovered communication terminal 11. Also, at least one of the communication nodes that are present in the communication route between the communication terminals 11 and the cloud system 12 may be determined in advance to be a component that is in charge of the calculation.

Note that the cloud system 12 is not necessarily the component that is in charge of the final calculation. In some cases, the cloud system 12 may perform calculation first, and the communication network 13 may take over the calculation of the cloud system 12.

In a case where the series of calculation of the DNN is processed in a distributed manner, the calculation range of which the components that are in charge of the calculation are caused to be in charge, in other words, how the assignment ranges are to be determined is also important. In yet other words, where the series of calculation of the DNN is to be separated is also important. The location where the DNN is separated will also be referred to as a splitting point. In the example in FIG. 2, splitting points are set between the second layer and the third layer and between the fourth layer and the fifth layer, and the DNN is separated into three ranges.

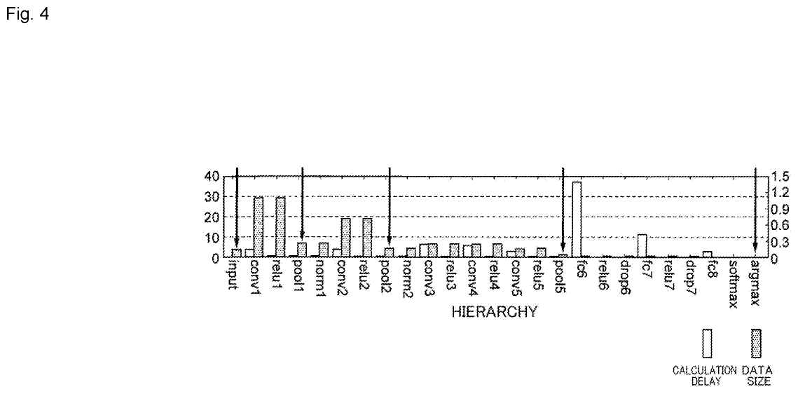

FIG. 4 is a diagram for explaining differences in delays and the amounts of output data in accordance with the splitting points. The bar graphs with the dot patterns in FIG. 4 illustrate the amounts of data output in a case where calculation from the input layer to the layers corresponding to the bar graphs is performed. It is possible to ascertain from FIG. 4 that the amounts of data output from the layers are not uniform and the DNN is preferably not separated at the layer outputting a large amount of data since the communication delay does not become large. Also, the white bar graphs in FIG. 4 illustrate calculation delays of the layers corresponding to the bar graphs. For example, it is possible to ascertain that it takes time to perform the calculation of the fc6 since the white bar graph corresponding to the layer named “fc6” is high. Therefore, it is possible to ascertain that a device with high calculation capability is preferably caused to be in charge of the calculation of the fc6 layer.

In this manner, the calculation delay and the communication delay vary depending on the assignment ranges. Therefore, it is preferable to determine the assignment range of each component that is in charge of the calculation as well when the components that are in charge of the calculation are determined.

However, even if the calculation of the DNN is distributed, and the delay of the ML application is successfully reduced, the delay may increase due to a change in condition of the information processing system 1. For example, since the spare calculation capacity of the components that are in charge of the calculation is not always constant, the calculation delay varies. Also, in a case where a wireless communication network is included in the communication network 13, quality of the wireless communication link frequently varies, and a communication delay is likely to vary. Additionally in a case where the communication terminals 11 are portable, communication routes and the like are also changed due to movement of the communication terminals 11. Moreover, a network topology may vary. An execution delay of the application may exceed the allowable limit due to such a change in conditions regardless of the fact that the execution delay was within the allowable limit.

For example, the aforementioned IAB network is adapted for the purpose of integrating the backhaul link and the access link, and not only the access link but also the backhaul link are wireless lines. Therefore, the condition of the communication link is likely to change. For this reason, in a case where the IAB network is included in the communication network 13 according to the present embodiment, the communication delay is likely to vary, and there is a concern that the execution delay may deteriorate as compared with a case where the calculation of the DNN is not distributed if the original components that are in charge of the calculation and the assignment ranges are maintained as they are.

Thus, the distribution is dynamically changed on the basis of the condition of the information processing system 1 in the present embodiment. More specifically the components that are in charge of the calculation, the assignment ranges, the communication routes between the components that are in charge of the calculation, and the like are changed on the basis of conditions of candidates for the calculation assigned components that may become the components that are in charge of the calculation and conditions of the communication link between the candidates for the calculation assigned components.

Note that, the communication nodes in the network perform relay communication in the IAB network. In this manner, it is possible to secure a communicable region (coverage) even in millimeter wave communication. Also, the backhaul link and the access link are made to orthogonally intersect each other in the level of physical layers by using not only conventional time division multiplexing (TDM) but also frequency division multiplexing (FDM) or space division multiplexing (SDM), it is possible to perform communication with higher efficiency as compared with the relay communication in a relatively high communication layer such as a layer 3. Also, the IAB network assumes communication using millimeter waves, in particular, and it is possible to improve the coverage problem in the millimeter wave communication by using the relay communication as in the IAB network and to efficiently expand the coverage. The IAB network also assumes multi-hop communication, and future development to a mesh type is also assumed.

Note that the IAB network is not limited to the millimeter wave communication. For example, it is also possible to apply the IAB network to vehicle tethering with an IAB node mounted in a vehicle, a moving cell with an IAB node mounted in a train, a drone cell with an IAB node mounted in a drone, and the like. In addition, an application to communication for Internet-of-things (IoT) is also assumed. Particularly, it is possible to apply the IAB network to wearable tethering communication and the like for establishing connection between a smartphone and a wearable device. In addition, it is possible to apply the IAB network to medical and factory automation regions. The same applies to a case where the IAB network is applied to the present embodiment.

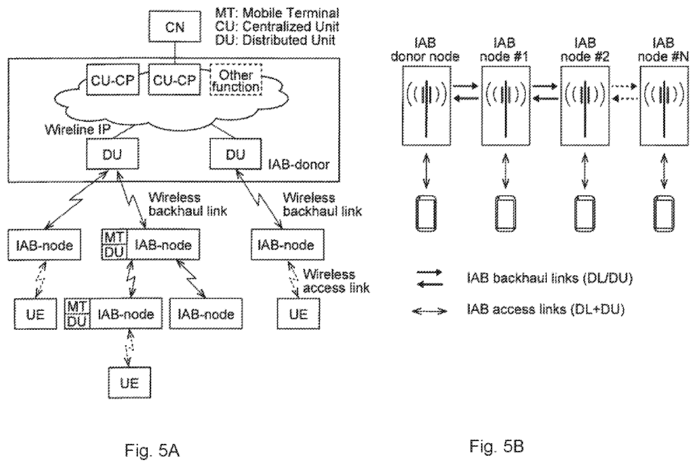

Note that a known architecture may be used as an architecture of the IAB network. FIG. 5 is a diagram illustrating an example of the architecture of the IAB network. As illustrated in FIG. 5(A), a communication node such as a next generation node B (gNB) is assumed as an IAB-donor corresponding to the donor node 132. Under the communication node, IAB-nodes that are relay nodes and correspond to the wireless communication nodes 131 are present and are connected in a wireless manner while configuring a plurality of multi-hops. Each IAB-node connects user equipment (UE) corresponding to the communication terminal 11 with an access link. The IAB-node may be connected to a plurality of IAB-nodes to improve redundancy of the backhaul link. The IAB-node includes a function as UE (MT) and a function as a communication node (DU). In other words, the IAB-node operates as MT when it performs downlink (DL) reception and uplink (UL) transmission and operates as DU when it performs DL transmission and UL reception, by using the backhaul link. Since the IAB-node is seen like an ordinary base station from the UE, the UE can be connected to the IAB network as illustrated in FIG. 5(B) even if the UE is a legacy terminal. Note that the combination is not limited to MT and DU and a combination of MT and MT or the like may be used.

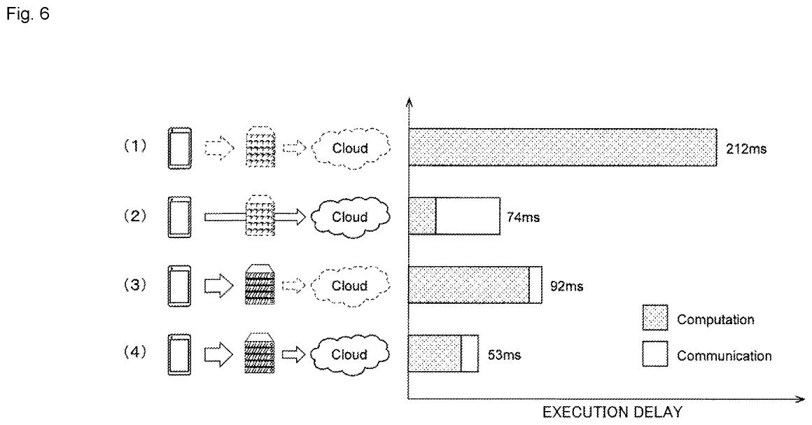

Effects of the distribution and the dynamic change of the calculation of the DNN will be described. FIG. 6 is a diagram illustrating effects of the distribution of the calculation of the DNN. The bar graph (1) illustrates an execution delay in a case where the communication terminal 11 alone executes the calculation of the DNN. The bar graph (2) illustrates an execution delay in a case where the communication terminal 11 and the cloud server in the cloud system 12 execute the calculation of the DNN. The bar graph (3) illustrates an execution delay in a case where the communication terminal 11 and a multi-access edge computing (MEC) server that is a kind of an edge server and is included by the communication node in the communication network 13 execute the calculation of the DNN. The bar graph (4) illustrates an execution delay in a case where the communication terminal 11, the MEC server, and the cloud server execute the calculation of the DNN. In addition, the parts with the dot pattern of the bar graphs represent calculation delays, and the white parts represent communication delays.

Note that a commercially available laptop computer is used as the communication terminal 11, a server equipped with Ryzen (registered trademark) 3800X as a central processing unit (CPU) and a memory of 32 giga byte (GB) is used as the MEC server, and a server equipped with a CPU of Intel (registered trademark) Core i9-9900 and a memory of 128 GB is used as the cloud server, such that the cloud server has a smaller calculation delay than the MEC server. Also, the communication capacity between the communication terminal 11 and the MEC server is set to 100 mega bit per second (Mbps), and the communication capacity between the MEC server and the cloud server is set to 30 Mbs. Note that Residual Network (ResNet) 18 which is a kind of a convolution neural network is used as the DNN.

As illustrated in FIG. 6, the execution delay was 212 millisecond (ms), which is the largest, while there is no communication delay in the case of (1). In the case of (2), the communication delay increases. In the case of (3), although the communication delay is reduced due to the MEC server being located close to the communication terminal 11, the calculation delay increases because the MEC server has lower calculation capability than the cloud server, and the execution delay is thus larger than that in the case of (2). On the other hand, in the case of (4), the calculation delay is larger than that in the case where the cloud server executes the entire calculation of the DNN, and the communication delay is larger than that in the case where the MEC server executes the entire calculation of the DNN, while the calculation delay is smaller than that in the case where the MEC server executes the entire calculation of the DNN, and the communication delay is smaller than that in the case where the cloud server executes the entire calculation of the DNN. Additionally in the case of (4), the execution delay is 53 ms, which is the smallest.

In this manner, it is possible to ascertain that the execution delay can be reduced by using the communication nodes in the communication network 13 as well for the distribution of the calculation of the DNN. Note that since the calculation delays and the communication delays differ depending on the assignment ranges as illustrated in FIG. 4 described above, the simulation results in FIG. 6 may change depending on the assignment ranges. In other words, although the execution delay in the case of (4) described above may become larger than those in the cases of (1) to (3) described above depending on the assignment ranges, it is possible to reduce the execution delay in the case of (4) described above as compared with those in the cases of (1) to (3) described above by appropriately setting the assignment ranges.

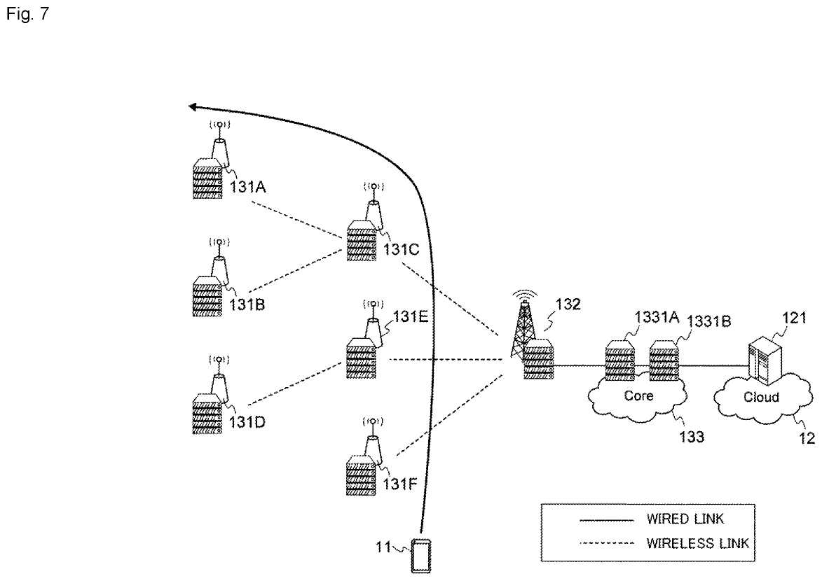

In addition, effects of the dynamic change in the distribution of the calculation of the DNN will also be described. FIG. 7 illustrates a diagram of a network topology in the IAB network used for the simulation. The network in the example of FIG. 7 is configured of ten nodes, and the ten nodes include wireless communication nodes 131A to 131F in the IAB network, the donor node 132 in the IAB network, the communication nodes 1331A and 1331B in the core network 133, and the cloud server 121. Note that the specs of the wireless communication nodes 131A to 131F are the same as that of the MEC server used when the effects of the distribution of the calculation of the DNN in the example in FIG. 6 are illustrated, and the specs of the donor node 132, the communication nodes 1331A and 1331B, and the cloud server 121 are the same as that of the cloud server used when the effects of the distribution of the calculation of the DNN described above are illustrated. Additionally the access link and the backhaul link of the IAB network are assumed to share the communication capacity of 4 giga bit per second (Gbps). The communication link between the donor node 132 and the communication node 1331A is a wired link of 1 Gbps, the communication link between the communication nodes 1331A and 1331B is a wired link of 400 Mbps, and the communication link between the communication node 1331B and the cloud server 121 is a wired link of 100 Mbps.

Also, a commercially available laptop computer as described above is used as the communication terminal 11, and the communication terminal 11 is assumed to have moved as illustrated by the arrow in FIG. 7. The communication terminal 11 is first connected to the closest wireless communication node 131F, and the wireless communication node 131 to which it is connected is switched with movement. Therefore, the communication route to the cloud server 121 is also switched. Therefore, the components that are in charge of the calculation and the assignment ranges are determined and are caused to execute the calculation of the DNN every time the communication route is switched.

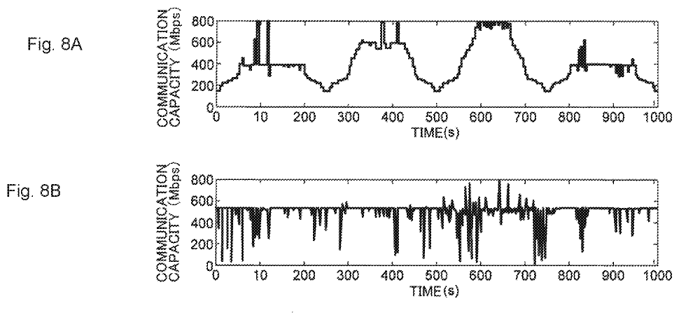

Also, in order to simulate variations in wireless communication link, variations in communication capacity for the simulation are defined. FIG. 8 is a diagram illustrating variations in communication capacity for the simulation. FIG. 8(A) illustrates variations in communication capacity of the access link between the communication terminal 11 and the wireless communication node 131 in FIG. 7. FIG. 8(B) illustrates variations in communication capacity between the wireless communication nodes 131 in FIG. 7. In the example of the access link, the communication capacity is caused to vary from 200 Mbps to 800 Mbps with elapse of time. Influences of the delay due to the variations in wireless communication link are simulated by using the variations in link.

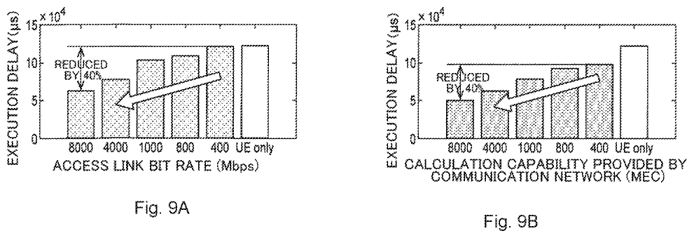

FIG. 9 is a diagram illustrating influences of resources in the communication network 13 on the execution delay. FIG. 9(A) illustrates a relationship between the communication capacity and the execution delay between the communication terminal 11 and the IAB node. The bar graphs in FIG. 9(A) represents execution delays, and the bar graphs of higher communication capacity in the wireless communication link are shorter toward the left side. In other words, the execution delays are further improved with an increase in communication capacity of the wireless communication link. Conversely in a case where quality of the wireless communication link is degraded, and the communication capacity decreases, the execution delay also increases at the same time. Since the quality of the wireless communication link is likely to vary, it is necessary to change the setting for the distribution in consideration of the quality of the wireless communication link when the calculation of the DNN is distributed.

Also, FIG. 9(B) illustrates a relationship between spare calculation capacity of the IAB node that is in charge of the calculation and the execution delay. The bar graphs with higher spare calculation capacity are shorter toward the left side even in FIG. 9(B), and it is possible to expect further reduction of the amount of delay as the spare calculation capacity of the IAB node increases. Also, since each layer of the DNN leads to a different calculation delay as illustrated in FIG. 9, it is necessary to determine the assignment ranges in accordance with variations in spare calculation capacity of the IAB node.

In this manner, although the resources of the communication network 13 such as quality of the communication link and the spare calculation capacity of the communication nodes affect the execution delay these may vary with time due to a change in network topology a change in application requirement, and the like, and the distribution of the calculation of the DNN is dynamically changed to follow the variations. In other words, it is preferable to dynamically change the components that are in charge of the calculation, the assignment ranges, the communication route, and the like in view of conditions such as quality of the communication link and the spare calculation capacity and each of the components that are in charge of the calculation.

A series of processing to perform distribution and dynamic change of the calculation of the DNN will be described. First, examples of a key performance indicator (KPI) needed to perform the distribution of the DNN, a control target, and information to be used will be described below.

The KPI is an execution delay of the ML application as described above. The execution delay of the ML application includes at least a calculation delay of each component that is in charge of the calculation and a communication delay between the components that are in charge of the calculation. Note that a delay caused by processing performed until calculation of the assignment range of the component that is in charge of the calculation is started after it receives a calculation result from the previous component that is in charge of the calculation is not taken into consideration and the sum of each calculation delay and each communication delay may be regarded as the execution delay.

As the control target, routing, DL or UL setting (DL/UL configuration) of each communication node, splitting points of the DNN, and the like are assumed.

As the information to be used, processing capability of each candidate for the component that is in charge of the calculation, a condition of each wireless communication link, a requirement specification of the ML application, a requirement specification of the communication network 13, a moving condition (mobility) of the communication terminal 11, and the like are assumed. Note that the candidates for the calculation assigned components are the communication terminal 11, the cloud system 12, and the communication nodes in the communication network 13, whether the communication terminal 11 and the cloud system 12 are to be in charge of the calculation may be determined in advance, and in such a case, the communication terminal 11 and the cloud system 12 may be excluded from the candidates for the calculation assigned components.

As the processing capability of each candidate for the component that is in charge of the calculation, calculation capability (capacity), spare calculation capacity at present, and the like are assumed. For example, the calculation may be assigned to a candidate for a calculation assigned component that has the highest calculation capability from among the candidates for the calculation assigned components that belong to the communication network 13 first, and in a case where the spare calculation capacity of the component that is in charge of the calculation decreases to a predetermined threshold value or below, the assigned candidate may be changed to another calculation assigned candidate that has sufficient spare calculation capacity. In this manner, the component that is in charge of the calculation may be changed on the basis of the spare calculation capacity of the component that is in charge of the calculation.

As the conditions of the communication link, the communication capacity, the communication quality and the like are conceivable. Note that the IAB network includes conditions of the backhaul link and the access link.

As the requirement specification of the ML application, an allowable limit of the execution delay of the ML application, in other words, an upper limit value of the execution delay that the ML application allows is assumed. Also, allowable upper limit values may be defined individually for the communication delay and the calculation delay as well.

As the requirement specification of the communication, an upper limit value of a traffic in each link is assumed. Also, an upper limit value of the traffic on a route set between the communication terminal 11 and the cloud system 12 may be set. These upper limit values may be determined on the basis of the requirement specification of the ML application and the splitting points of the DNN. The movement conditions of the communication terminal 11 may be any information as long as it is related to movement, such as a movement speed, a movement direction, and a movement pattern.

Next, a main component that determines the components that are in charge of the calculation and the assignment ranges will be described. The determination of the components that are in charge of the calculation and the assignment ranges may be performed any of the devices belonging to the information processing system 1, and the device is not particularly limited. In other words, the main component that determines the components that are in charge of the calculation and the assignment ranges may be appropriately defined. Note that in the case where the devices belonging to the information processing system 1, such as the communication terminal 11, the communication node, and the cloud server, are not distinguished, these will be referred to as entities, and the main component that determines the components that are in charge of the calculation and the assignment ranges will be described as a logical entity.

For example, a server that makes the determination may be mounted in a communication node in the communication network 13 or the cloud system 12 and may be caused to serve as the logical entity, or a module that is in charge of the determination of the components that are in charge of the calculation and the assignment ranges may be mounted in infrastructure for performing communication in the communication nodes and may be caused to serve as the logical entity.

However, in order to determine the components that are in charge of the calculation and the assignment ranges, it is preferable to constantly recognize the conditions of the resources in the information processing system 1, and a device that is present at a position suitable for communication therefor preferably becomes the logical entity.

Also, one logical entity may determine both the components that are in charge of the calculation and the assignment ranges, or a logical entity that determines the components that are in charge of the calculation and the logical entity that determines the assignment ranges may be separately defined.

The resources of the information processing system 1 include spare calculation capacity of the candidates for the calculation assigned components that belong to the information processing system 1, communication capacity and communication quality of the communication link in the communication network 13, and the like.

As the variations in communication environment, quality of the communication link, spare calculation capacity of the communication nodes, network topology variations in communication route, and the like are assumed.

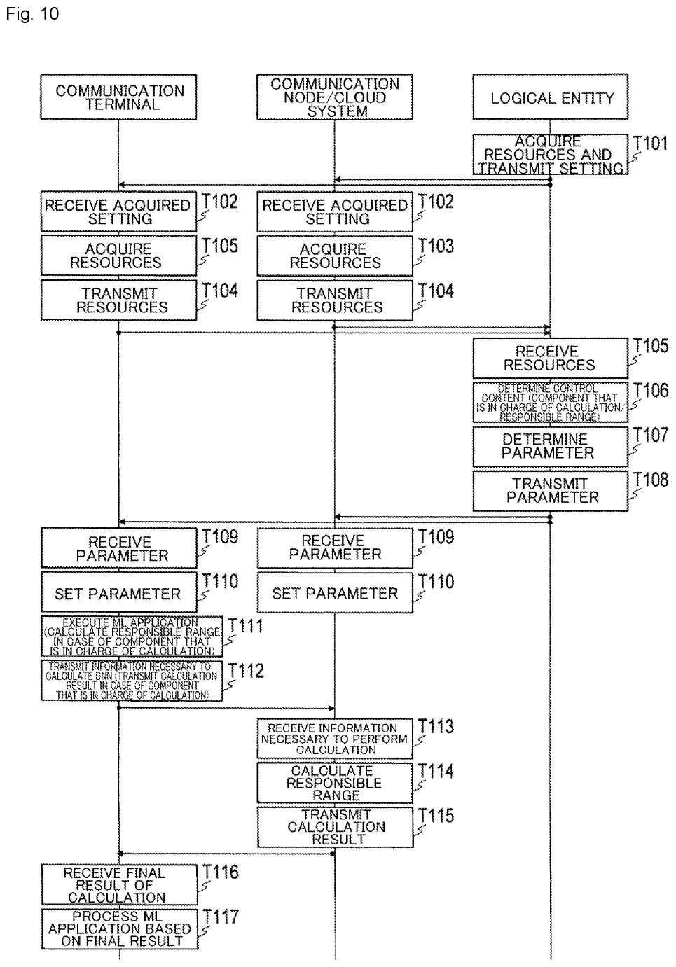

A flow of processing according to the present embodiment will be described. FIG. 10 is an overview sequence diagram illustrating a flow of overall processing according to the present embodiment. Note that the communication node and the cloud server are represented as a set for convenience of explanation in FIG. 10.

Also, the entities of the information processing system 1 are assumed to be configured of components that are in charge of each part of the processing although not illustrated in the drawing. In this description, the logical entity includes a reception unit, a transmission unit, and a determination unit. Also, each of the candidates for the calculation assigned components such as the communication terminal 11, the communication node, and the cloud server includes a reception unit, a transmission unit, an acquisition unit (measurement unit), a setting unit, and a calculation unit. The main components of each part of the processing in FIG. 10 are assumed to be the components described above.

The transmission unit of the logical entity transmits setting regarding acquisition and transmission of information regarding resources of the information processing system 1 used to determine the components that are in charge of the calculation to each of the entities such as the communication terminal 11, the communication node, and the cloud server (T101; measurement configuration). The reception unit of each entity receives the acquired setting from the logical entity (T102), the acquisition unit of each entity acquires the information regarding the resources on the basis of the setting (T103), and the transmission unit of each entity transmits the acquired information regarding the resources to the logical entity on the basis of the setting (T104).

The reception unit of the logical entity receives the information regarding the resources from each entity (T105), and the determination unit of the logical entity determines control content of each entity to cause the execution delay of the ML application to fall within the allowable limit (T106). Whether the calculation is assigned to a component is determined as the control content although this will be described later. Furthermore, the determination unit of the logical entity determines parameter values set for the communication terminal 11 and the communication node, in other words, setting values to realize the determined control content (T107; parameter configuration). The determined setting values are transmitted to the communication terminal 11 and the communication node by the transmission unit of the logical entity (T108).

The reception unit of each entity receives the setting values from the logical entity (T109), and the setting unit of each entity sets parameters for causing each entity to operate to the setting values (T110). In this manner, an environment to execute the ML application that is suitable for the current resource conditions is arranged.

Thereafter, the communication terminal 11 executes the ML application (T111). Note that in a case where the communication terminal 11 is designated as a component that is in charge of the calculation, the calculation unit of the communication terminal 11 performs the calculation of the assigned calculation range. Then, the transmission unit of the communication terminal 11 transmits information necessary to the calculation of the DNN to a designated destination (T112). A result of calculation obtained in the middle of the series of calculation of the DNN is included in the information in a case where the communication terminal 11 is designated as a component that is in charge of the calculation, or an input to the DNN is included in the information in a case where the communication terminal 11 is not designated as the component that is in charge of the calculation. Also, the designated destination is a component that is in charge of the next calculation.

The reception unit of the component that is in charge of the next calculation receives the information necessary to the calculation of the DNN (T113), the calculation unit of the component that is in charge of the next calculation performs the calculation of its own assignment range (T114), and the transmit unit of the component that is in charge of the next calculation transmits the result of the calculation to the component that is in charge of further next calculation (T115). The processing in T113 to T115 is performed by each component that is in charge of the calculation. Note that the entities that have not been designated as the components that are in charge of the calculation do not perform the calculation of the DNN. Also, the transmission unit of the component that is in charge of the final calculation replies the result of the calculation to the communication terminal 11. The reception unit of the communication terminal 11 receives the result of the final calculation of the DNN (T116), and the processing of the ML application is executed on the basis of the result of the final calculation (T117). In this manner, the processing of the ML application is completed.

Note that even after the processing of the ML application is completed, each entity may perform acquisition and transmission of the resources on the basis of acquired setting, and the logical entity may determine whether or not the execution delay exceeds the allowable upper limit value every time the resources are received and may change the control content in a case where the execution delay is determined to exceed the allowable upper limit value. In this manner, preparation may be made for a case where the ML application is executed again. Note that acquisition and transmission of the resources may be stopped and the acquisition and the transmission of the resources may be restarted in a case where activation of the ML application is detected or the like.

Each part of the processing in the above sequence will be supplementarily described. First, the information to be acquired will be described.

The information that the logical entity provides a command to acquire may be information regarding calculation power. Examples of the information regarding the calculation power include maximum calculation capability (capability), spare calculation capacity a calculation load (calculation amount), the amount of calculation delay assumed from the calculation load, and the like. For example, the number of graphical processing units (GPUs) included by each entity may be used as the maximum calculation capability. Also, the number of GPUs that have not been used until now may be used as the spare calculation capacity.

Also, the information may be information regarding conditions of the connected communication link. For example, the information may be information regarding wireless communication link connection such as a radio link failure or information regarding communication quality of the wireless communication link such as reference signal received power (RSRP), reference signal received quality (RSRQ), or a reference signal strength indication (RSSI). Also, information regarding a throughput or a delay of the communication link may be used.

Also, the information may be information related to a required specification of the ML application. For example, there is an upper limit value or the like of a delay that the ML application allows. Note that the required specification of the ML application may be different for each communication terminal 11.

Also, the information may be information related to a traffic of the communication network 13. Examples thereof include an upper limit value of the traffic, a buffer status of the traffic, and the like. Note that an estimated value may be used instead of an actually measured value of the traffic.

Also, the information may be information related to movement (mobility) of the communication terminal 11. The communication terminal 11 may move during execution of the ML application. Since movement may affect communication quality information such as a movement speed and a movement direction, for example, may be acquired.

Additionally the information may be information related to calculation of the DNN. For example, each entity may be caused to estimate a calculation delay for each layer of the DNN. Alternatively a plurality of assignment range candidates may be determined in advance, and the logical entity may provide an instruction to estimate a calculation delay of each assignment range candidate to each of the entities. Also, each entity may be caused to estimate a load (such as a GPU use rate, for example) due to the calculation of the DNN. Note that the calculation delay may be calculated on the basis of a past calculation history or may be calculated as a logical value at the time of calculating the data size illustrated in FIG. 4 on the assumption that the current spare calculation capacity will continue.

Note that the entities may actually measure the information designated by the instruction and transmit the actually measured values to the logical entity. Alternatively, future estimated values calculated on the basis of the actually measured values may be transmitted of the logical entity. For example, if a scheduled execution clock time of the ML application is 10 seconds later, a predicted position of the communication terminal 11 after 10 seconds may be transmitted to the logical entity. Also, the communication terminal 11 and the communication nodes may quantize the actually measured values, determine which of predefined categories the actually measured values correspond to, and transmit information regarding the corresponding category to the logical entity. The estimation may be performed on the basis of recording accumulated until then.

As a method of acquiring information related to resources, a known technique may be used. For example, information related to performance of each entity such as calculation capability and spare calculation capacity may be acquired by using a function of a tool provided by an operating system (OS) or the like mounted on the entity. Also, information related to quality of the communication link, for example, communication quality of RSRQ or the like may be checked by using a known technique.

Additionally there may be a communication node that behaves as a representative by collecting information to be transmitted to the logical entity and transmitting it to the logical entity as a representative. In such a case, the information regarding a traffic of each link and movement of the communication terminal 11, for example, may be transmitted to the logical entity after the information from the plurality of communication nodes is combined.

Also, a timing or the like of acquiring the information may be designated. An instruction to perform periodical acquisition (periodical measurement) may be provided. For example, the logical entity may determine the acquisition start time, the acquisition end time, and the acquisition period and provide an instruction thereof to each entity, and each entity may perform the acquisition in accordance with the instruction. Also, an instruction for the number of times of acquisition, a repeated standby period, and the like may also be provided. Additionally dynamic acquisition (trigger-based measurement) may be performed. A trigger condition for each entity to dynamically start the acquisition may be appropriately determined. For example, the acquisition may be started when an abnormality (failure) of the wireless communication link is detected. Alternatively the acquisition may be started in a case where a processing load of each node, a delay of the ML application, a communication delay or the like exceeds a predetermined threshold value. Note that such a threshold value may be adjusted by the logical entity. Alternatively, the acquisition may be started when a request for acquisition is received. The request may be transmitted from the logical entity or may be transmitted from a higher-order node that is different from the logical entity.

For example, designation to execute measurement of RSRQ of the backhaul link in a period of 10 ms, for example, periodically at an interval of 100 ms, for example, to measure quality of the backhaul link may be performed.

Transmission of such information to the logical entity, in other words, a report may be performed as needed, and the transmission timing and the format of the transmitted data are not particularly limited. In a case where an instruction to periodically acquire information is provided, for example, the transmission may also be performed periodically. Alternatively the transmission may be performed in a case where some condition is met, such as when the value of RSRQ of the communication link becomes equal to or less than a predetermined threshold value or when the processing load of each node becomes equal to or greater than a predetermined threshold value. Also, the transmission may be performed immediately after the acquisition, or the transmission may be performed after elapse of an offset time from the acquisition. Alternatively the transmission may be performed when the acquired value satisfies a condition. For example, a report may be issued in a case where there is a variation to such an extent that it is necessary to change the components that are in charge of the calculation, the assignment ranges, or the like, and the report may not be issued otherwise.

Also, each entity may not transmit the entire acquired information to the logical entity. For example, each entity may acquire information with fine granularity and may transmit, to the logical entity, only information that satisfies a predetermined condition, such as information with a large variation or information that has exceeded a threshold value, out of the acquired information. In other words, the logical entity may provide separate instructions for information to be acquired and information to be reported. Also, the acquired information may be appropriately processed to be reported to the logical entity.

Also, the setting may be different for each entity. Since the communication link connected to the cloud system 12 is assumed to be wired and stable, for example, it may not be necessary for the cloud system 12 to acquire information regarding the communication link.

Next, determination of control content will be described. The control content to be determined includes control content related to the communication link and the wireless communication parameters. Also, the components that are in charge of the calculation, the assignment ranges, and the like are also determined.

Examples of control related to the communication link include determination of a communication route. In a case where the communication network 13 includes a network of a relay scheme such as an IAB network, for example, a relay route is determined. Note that even if it is attempted to choose a component that is in charge of calculation from among the communication nodes on the communication route between the communication terminal 11 and the cloud system 12, it is not possible to choose any as long as there are no communication nodes with spare calculation capacity on the communication route. Therefore, the logical entity may determine the communication route using not only the quality of the communication link but also the calculation capability, spare calculation capacity and the like of the communication nodes. Also, a change in IAB node to pass through and a change in number of hops may be performed in a similar manner.

Examples of the control related to the communication parameters include an improvement in quality of the communication link on the communication route. This can lead to a decrease in communication delay. For example, transmission of a setting value to raise intensity (transmission power) of wireless radio waves to be transmitted from the logical entity to the wireless communication nodes 131 on the communication route is conceivable. Also, the wireless communication nodes 131 may be caused to reduce communication capacity of the wireless communication link which is not on the communication route to prevent interference. The setting value to improve the quality of the communication link may be determined in this manner.

Also, a correspondence between downlink (DL) and uplink (UL) in the wireless communication link may be changed as the control related to the wireless communication parameters. The wireless communication link can perform adjustment to increase a communication band for one of DL and UL and to reduce a communication band for the other. Therefore, the correspondence between DL and UL may be adjusted to reduce the communication delay. Note that the communication delay may be calculated from the size of the data to be transmitted and the communication capacity of the communication link through which the data flows. A delay due to the communication quality may also be taken into consideration.

However, interference is likely to occur if the communication bands are adjusted. For example, cross link interference (CLI) with the IAB network link is likely to occur in the IAB network. Therefore, it is necessary to pay sufficient attention at the time of the adjustment of the communication bands.

The components that are in charge of the calculation and the assignment ranges are determined in view of the spare calculation capacity of each wireless communication node 131, the amount of data output in each assignment range, quality of the communication link on the communication route, and the like. They are determined such that at least a wireless communication node 131 that may be a bottleneck of a delay does not become a component that is in charge of the calculation.

However, a load and a time are needed to search for optimal solutions of the components that are in charge of the calculation and the assignment ranges. This is because the number of candidates for the calculation assigned components exponentially increases depending on the communication route and the number of layers in the DNN. Therefore, it becomes easier to perform the processing by narrowing down the candidates for the calculation assigned components and searching for suboptimal solutions in advance. For example, a plurality of combinations of assignment ranges may be prepared in advance, and a combination to be used may be changed in accordance with a condition of the communication environment. Here, the combinations of the assignment ranges prepared in advance will also be referred to as splitting modes.

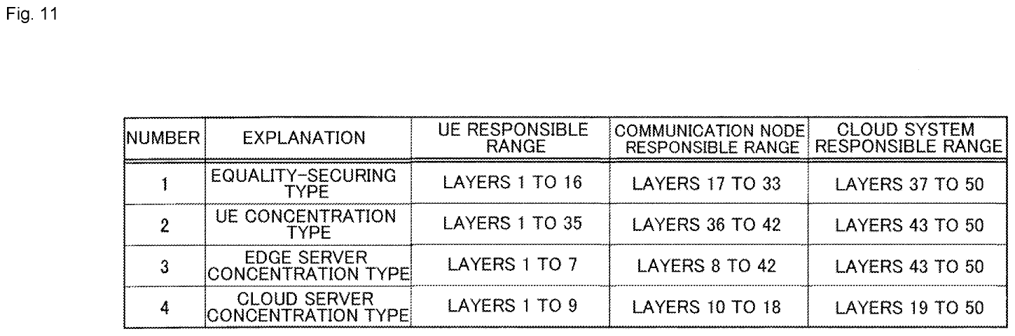

FIG. 11 is a diagram for explaining the splitting modes. FIG. 11 illustrates four splitting modes. Note that a table illustrating a plurality of splitting modes as in FIG. 11 will also be described as a splitting mode table. In the example in FIG. 11, the assignment range of each component that is in charge of the calculation is determined by selecting a splitting mode that minimizes the execution delay of the ML application from among the four splitting modes. Note that although the communication terminal 11, the communication nodes in the communication network 13, and the cloud system 12 are components that are in charge of the calculation in the example in FIG. 11, a splitting mode in which components that are in charge of the calculation are different may be prepared. Also, a specific splitting mode may be selected as a default at the time of initial start of the execution of the ML application and may be switched to another splitting mode after that, for example. In a case where loads of components that are in charge of the calculation other than the communication terminal 11 are determined to be high, for example, selecting a splitting mode in the second row in which assignment ranges of the components that are in charge of the calculation other than the communication terminal 11 are small and causing the communication terminal 11 to receive the loads instead is conceivable. In such a case where there are loads on specific components that are in charge of the calculation, it is possible to easily achieve an improvement by switching the splitting mode to another splitting mode in which the assignment ranges of the components that are in charge of the calculation are small. Note that inspection to determine whether or not to switch the splitting mode may be periodically executed or may be dynamically executed.

Both a splitting mode that is used in a normal time and a temporary splitting mode that is used in a case where it is determined that a requirement of the ML application cannot be met in the splitting mode that is used in a normal time may be determined in advance. It is thus possible to quickly switch the splitting modes without performing processing of appropriately selecting a splitting mode in the case where it is determined that the requirement of the ML application is not met.

In this manner, the dynamic change of distribution may be facilitated by preparing candidates of assignment ranges in advance. Also, the content of the splitting modes, that is, the assignment range of each component that is in charge of the calculation may be appropriately updated by the logical entity. Note that each entity is notified the updated splitting mode one after another to prevent each component that is in charge of the calculation from performing the calculation on the basis of the splitting mode before the updating.

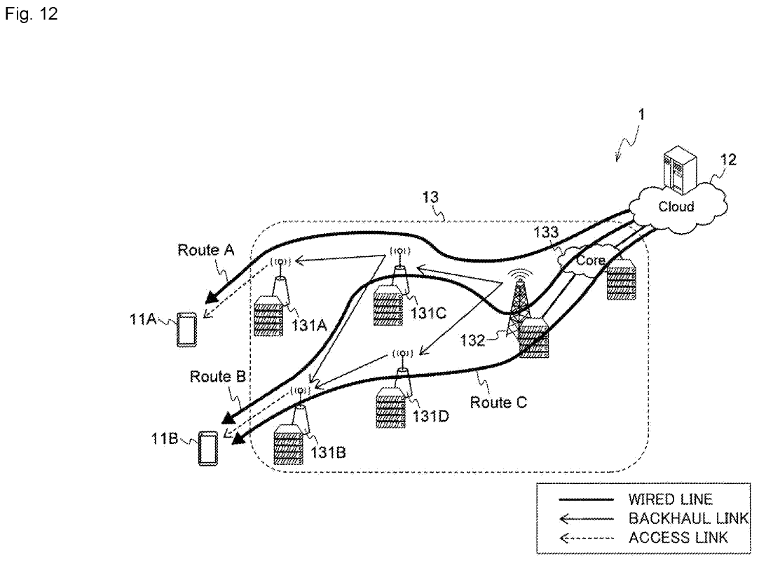

Also, the splitting mode may be set for each communication route. FIG. 12 is a diagram for explaining a splitting mode set for each communication route. FIG. 12 illustrates three communication routes Route_A, Route_B, and Route_C. A plurality of splitting modes as illustrated in FIG. 11 are set for each of these three communication routes.

For example, in the communication route Route_A, the cloud system 12, the communication nodes in the core network 133, the donor node 132, the wireless communication node 131C, the wireless communication node 131A, and the communication terminal 11A that are present on the communication route Route_A are candidates for calculation assigned components. The layers of the DNN are allocated to these candidates for the calculation assigned components to create a splitting mode table. Similarly candidates for calculation assigned components are chosen for the communication routes Route_B and Route_C as well to create splitting mode tables.

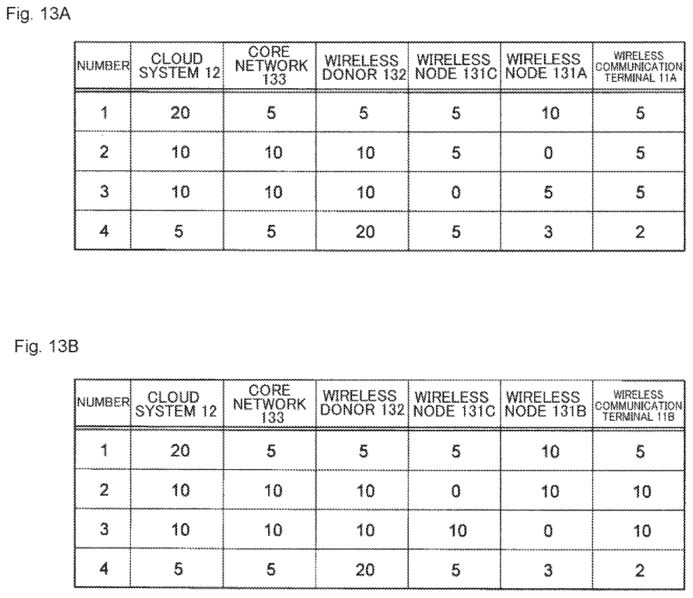

FIG. 13 is a diagram illustrating an example of splitting modes for each communication route. FIG. 13(A) illustrates the splitting mode table for the communication route Route_A, and FIG. 13(B) illustrates the splitting mode table for the communication route Route_B. In the example in FIG. 13, the number of layers in the DNN is assumed to be forty, and the numerical value of each cell in the splitting mode table indicates the number of layers assigned to the corresponding candidate for the component that is in charge of the calculation. Note that in a case where “0” is described in a cell, it means that there is no layer assigned to a corresponding candidate for the calculation assigned component. In other words, it means that the candidate does not serve as a component that is in charge of the calculation.

Note that although it is assumed that the logical entity determines the assignment range, that is, the splitting mode in the above description, a method in which the logical entity creates a splitting mode table and transmits the splitting mode table to the components that are in charge of the calculation and the components that are in charge of the calculation select a splitting mode can also be employed. When the communication terminal 11 performs handover and changes the wireless communication node 131 as a connection destination, for example, it is possible to reset a splitting mode by the communication terminal 11 selecting a splitting mode from the splitting mode table for the communication route after the change and notifying each component that is in charge of the calculation of the selected splitting mode.

Note that the assignment ranges of the components that are in charge of the calculation by using the wired link may be fixed. For example, since the cloud system 12 and the edge server of the core network 133 do not perform wireless communication, and there is considered to be only a small change in condition of the communication link. It is possible to reduce variations in splitting mode by fixing the assignment ranges of the components that are in charge of the calculation and are present at such a location where there are small amounts of variations in communication environments. For example, the splitting mode of the communication route Route_A illustrated in FIG. 13(A) includes seven candidates for the calculation assigned components, it is possible to perform allocation of suboptimal splitting modes by performing setting. It is possible to reduce the number of variations in splitting modes by fixing values allocated to the cloud system 12 and the core network 133.

Also, the logical entity may change the splitting mode table on the basis of an anchor point. The anchor point is a communication node that is always present on the communication route set for the communication terminal 11 as long as the communication terminal 11 is located in an assumed moving area. Although the communication route is changed by movement of the communication terminal 11, the communication node that is common for all the communication routes that can be set in the assumed moving area of the communication terminal 11 is the anchor point. If the communication terminal 11 establishes wireless connection with any of the wireless communication nodes 131A to 131D in the example in FIG. 12, for example, the donor node 132 is always present on the communication route with the cloud system 12. Therefore, the donor node 132 is an anchor point in the example in FIG. 12. For example, the logical entity may determine a splitting mode in the splitting mode table unless the anchor point disappears from the communication route and may reset the splitting mode table itself in a case where it detects that the anchor point has disappeared from the communication route. In this manner, the splitting mode table may be recreated when the predetermined communication node disappears from the communication route.

Note that although the component that is in charge of the calculation transmits the calculation result to the next component that is in charge of the calculation after the calculation of the DNN in the assignment range ends in the above example, there may be a case where the calculation result is transmitted to the communication terminal 11 instead of the next component that is in charge of the calculation. For example, the component that is in charge of the calculation may check whether a condition for ending the series of calculation of the DNN, the result of which has been provided as a notification in advance, in the middle is satisfied, transmit the calculation result to the next component that is in charge of the calculation in a case where the condition is not satisfied, or determine that the calculation of the DNN may be ended and transmit the calculation result, that is, a calculation result obtained in the middle of the series of calculation of the DNN to the communication terminal 11. The breaking out the calculation in the middle without processing all the layers in the DNN to the end in this manner is referred to as early exiting.

As illustrated in FIG. 2, the ML application performs the target processing of the ML application on the basis of the calculation result of the DNN, in other words, an output from the output layer. Although the series of calculation of the DNN is performed to enhance precision of the target processing, the precision can be sufficiently high if the target processing is performed on the basis of the result obtained in the middle of the calculation of the DNN. Therefore, in a case where reliability of the target processing is determined to be in a specific level or higher even if the calculation result obtained up to the intermediate layer is used on the basis of the predetermined ending condition being satisfied, calculation of the DNN may be stopped.

Note that the ending condition may be appropriately defined and may be distributed to each component that is in charge of the calculation similarly to the splitting mode table or the like. Whether to perform early exit may be determined by using an output result using a Softmax function that is an activation function or a cross entropy value, and in this case, when the output value of the Softmax function is equal to or greater than a predetermined threshold value, the processing of the DNN may be ended in the layer, and early exit may be performed, for example.

Furthermore, the calculation may be ended even in the middle of the assignment range. When the third layer and the fourth layer are assignment ranges, for example, whether the calculation result of the third layer satisfies the ending condition may be determined. In this manner, whether or not to end the calculation may be determined for each layer of the DNN. Alternatively, the logical entity may designate a layer that executes the ending determination. Note that the layer that executes the ending determination is also referred to as an early exiting point.

Also, the logical entity may change the assignment range of each component that is in charge of the calculation in units of layers. For example, in a case where a load on the communication terminal 11 slightly increases after the assignment range of the communication terminal 11 is determined to be the layers 1 to 4, adjustment in which the assignment range of the communication terminal 11 may be changed to the layers 1 to 3 and the layer 4 excluded from the assignment range may be assigned to the next component that is in charge of the calculation may be performed. Although control with finer granularity than that in the splitting mode level is performed and the load on the logical entity increases in this case, it is possible to reduce the risk that the requirement of the ML application is not satisfied.

Next, parameter setting will be described. The communication terminal 11 and the communication nodes update parameter values related to the communication link, the assignment ranges, and the like in accordance with content determined by the logical entity. An instruction for the parameter setting may be provided directly from the logical entity or may be provided indirectly via a representative wireless communication node 131 that ties up the plurality of wireless communication nodes 131. The notification method is not particularly limited, and a signaling notification in an application layer may be provided, or a signaling notification in a physical layer may be provided. A quasistatic notification such as a radio resource control (RRC) signaling may be provided, or a dynamic notification such as downlink control information (DCI) or uplink control information (UCI) may be provided.

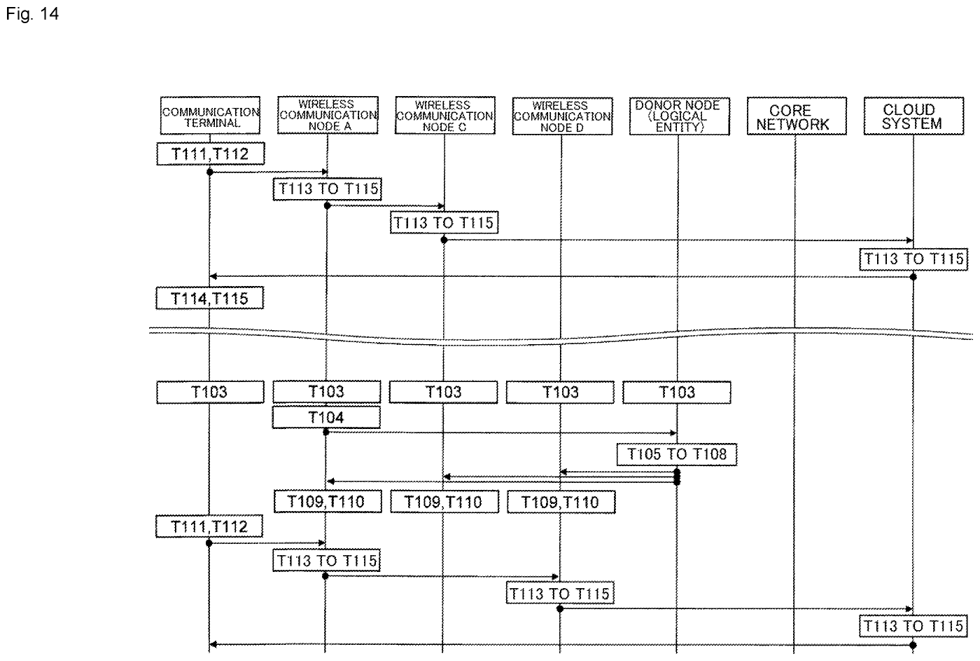

Furthermore, a sequence diagram when the components that are in charge of the calculation are switched is also illustrated. FIG. 14 is a sequence diagram before and after the components that are in charge of the calculation are switched. Note that reference signs for the processing illustrated in FIG. 10 are illustrated in the blocks in FIG. 14 for convenience of explanation.

In the example in FIG. 14, a case where the logical entity is mounted on the donor node 132 is illustrated. Also, it is assumed that although the communication terminal 11, the wireless communication node 131A, the wireless communication node 131C, and the cloud system 12 are components that are in charge of the calculation at the beginning, quality of the backhaul link of the wireless communication node 131A and the wireless communication node 131C deteriorates, and switching of the assignment ranges is executed. Note that it is assumed that the processing up to the parameter setting (T110) illustrated in FIG. 10 has been executed and processing from T111 is illustrated.

The ML application of the communication terminal 11 is executed (T111), and the communication terminal 11 transmits information necessary to the calculation of the DNN to the next component that is in charge of the calculation (T112). The wireless communication node 131A that is the next component that is in charge of the calculation receives the information (T113), performs calculation in the assignment range of the wireless communication node 131A itself (T114), and transmits the calculation result to the wireless communication node 131C that is the next component that is in charge of the calculation (T115). The wireless communication node 131C also executes the processing in T113 to T115 in a similar manner, and the calculation result of the wireless communication node 131C is transmitted to the cloud system 12 that is the next component that is in charge of the calculation. The cloud system 12 that is the next component that is in charge of the calculation also executes the processing in T113 to T115 in a similar manner, and the final calculation result of the DNN is transmitted from the cloud system 12 to the communication terminal 11 since the cloud system 12 is the final component that is in charge of the calculation.

Thereafter, cyclic acquisition of resources is executed by each entity (T103), and the wireless communication node 131A that detects a problem provides a report to the donor node 132 that is the logical entity (T104). Note that the example in FIG. 14 adopts setting in which the core network 133 and the cloud system 12 do not provide a report to the logical entity and the block of T104 is not illustrated in the core network 133 and the cloud system 12. Also, the other entities do not provide a report to the logical entity in a case where deterioration is not detected in the setting. Therefore, since the entities other than the wireless communication node 131A that has detected the problem do not provide a report, the block of T104 is not illustrated.

For example, each entity performs measurement for the backhaul link. Therefore, a situation in which the wireless communication node 131A detects that the RSRQ value of the backhaul link with the wireless communication node 131C has become equal to or less than a predetermined value and transmits the detection result to the logical entity is assumed.

The donor node 132 that is the logical entity receives the report from the wireless communication node 131A, determines that it is not sufficient to only increase the band of the backhaul link of the problem on the basis of the result of the reporting, determines new setting such as a change in components that are in charge of the calculation and the like, and transmits the setting to each entity (T105 to T108). Note that since the logical entity transmits the setting only to the entities that require new setting in the example in FIG. 14, the arrow indicating transmission is not illustrated for the core network 133 and the cloud system 12. Note that the setting may be transmitted to entities that do not require new setting.

Note that the logical entity may request an additional report from each entity. For example, a request to transmit a report of a traffic buffer and the like may be provided to the communication nodes in the surroundings of the wireless communication node 131A in order to examine whether it is possible to address a problem by increasing the band of the backhaul link when a report indicating that the problem has occurred in the backhaul link is received from the wireless communication node 131A.

Each entity that has received the new setting from the logical entity receives the new setting and sets it as a parameter (T109, T110). In the example in FIG. 14, it is assumed that the backhaul link from the wireless communication node 131A to the wireless communication node 131C has disappeared and the backhaul link from the wireless communication node 131A to the wireless communication node 131D has been newly set. In accordance with this, it is assumed that the communication route has been changed, the wireless communication node 131C that is not on the communication route has been excluded from the components that are in charge of the calculation, and the wireless communication node 131D has been added to the components that are in charge of the calculation.

Thereafter, the ML application is executed again (T111), and the communication terminal 11 transmits information necessary to the calculation of the DNN to the wireless communication node 131A that is the next component that is in charge of the calculation (T112). The wireless communication node 131A receives the information similarly to the previous time (T113), performs the calculation in the assignment range of the wireless communication node 131A itself (T114), and transmits the calculation result to the wireless communication node 131D that has newly become the next component that is in charge of the calculation rather than the wireless communication node 131C (T115). In this manner, the processing in T113 to T115 is not executed by the wireless communication node 131C unlike the previous time. The wireless communication node 131D also executes the processing in T113 to T115 in a similar manner, and the calculation result of the wireless communication node 131D is transmitted to the cloud system 12 that is the next component that is in charge of the calculation. The cloud system 12 that is the next component that is in charge of the calculation also executes the processing in T113 to T115 in a similar manner, and the final calculation result of the DNN is transmitted from the cloud system 12 to the communication terminal 11 since the cloud system 12 is the final component that is in charge of the calculation.

In this manner, it is possible to suppress a calculation delay caused by the entity of the problem and a communication delay due to the communication link of the problem by the components that are in charge of the calculation being changed, and it is possible to prevent an execution delay of the ML application from exceeding an allowable upper limit value.

Note that although it is determined that only increasing the band of the backhaul link is insufficient and the change in the communication route and the change in the components that are in charge of the calculation are performed in the example in FIG. 14, only the change in components that are in charge of the calculation may be performed in a case where it is determined that the problem can be addressed only by changing the assignment ranges. For example, a splitting mode that reduces the assignment range of the wireless communication node 131C may be selected from the splitting mode table as illustrated in FIG. 11. Also, if the assignment range of the wireless communication node 131A is from the layer 20 to the layer 25 of the DNN and the assignment range of the wireless communication node 131C is from the layer 26 to the layer 40 of the DNN until now, for example, the assignment range of the wireless communication node 131A may be increased from the layer 20 to the layer 29 of the DNN, and the assignment range of the wireless communication node 131D may be set to the layer 30 to the layer 40 of the DNN. In this manner, the wireless communication node 131C may be caused to continuously serve as a component that is in charge of the calculation.

Also, the change in the assignment ranges may be performed in a case where the components that are in charge of the calculation are changed as in the example in FIG. 14.

Note that the information processing system 1 includes the communication terminal 11, the communication network 13, and the cloud system 12 in this description and owners of these are assumed to be different in practice. Additionally, owners of the network for access of the communication terminal 11 such as an IAB network and the core network 133 are assumed to be different. Therefore, the range that the logical entity can indicate and set may be a part of the information processing system 1. In a case where the logical entity is a communication node in the IAB network, for example, the logical entity may not be able to change the calculation range of the cloud system 12 and may perform only the setting for the communication nodes in the IAB network.

As described above, the components that are in charge of the calculation, setting of the assignment ranges, the communication capacity of the communication link, the communication route, and the like is changed in a case where a time required to execute the ML application exceeds the upper limit value due to variations in resources of the information processing system 1 in the present embodiment. It is thus possible to suppress an influence of the variations and to cause the ML application to comfortably operate.

Note that in a case where an external device such as a cloud server is caused to perform the entire calculation of the DNN instead, an input to the DNN is transmitted from the communication terminal 11 to the external device. In a case where m nodes are included in the input layer, for example, input data configured of values such as an input 1, an input 2, . . . , an input m is transmitted to the outside of the communication terminal 11. However, a problem of this in terms of privacy and information leak has also been pointed out. Therefore, it is possible to alleviate such a problem by the communication terminal 11 being in charge of at least calculation from the beginning to a midpoint of the series of calculation of the DNN to prevent the input data itself from being transmitted to the outside.

Also, the subject that determines the components that are in charge of the calculation and the assignment ranges has been described as the logical entity and the communication node in the communication network 13, the cloud server, or the like is assumed to be caused to serve as the logical entity in the above description. For example, there has been a description that it is only necessary to use a device suitable for recognizing the conditions of the resources as the logical entity such that it is possible to determine the components that are in charge of the calculation and the assignment ranges in accordance with the conditions of the resources in the information processing system 1. Additionally there has been a description that a device that provides an instruction by which quality of the communication link is improved to the wireless communication node 131 on the communication route is used as the logical entity. Moreover, the communication terminal 11 can also be the logical entity. In other words, the communication terminal 11 may determine the components that are in charge of the calculation and the assignment ranges.

Also, as illustrated in FIG. 10 and the like, each entity such as the communication terminal 11 periodically transmits resources to the logical entity, and the logical entity determines the components that are in charge of the calculation and the assignment ranges on the basis of the resources of each entity and notifies each component that is in charge of the calculation of the determination result according to the above description. Therefore, the components that are in charge of the calculation and the assignment ranges are determined before the timing at which the communication terminal 11 activates the ML application or the timing at which the ML application executes the calculation of the DNN. However, the communication terminal 11 can determine the assignment range of the communication terminal 11 itself on its own by notifying the communication terminal 11 of the condition for determining the assignment ranges from the logical entity or the like in advance.

For example, the communication terminal 11 may check items such as the spare calculation capacity of the communication terminal 11 itself, a delay time of the cloud system 12, and the like at the time of the execution of the ML application and may determine up to which layer in the DNN the calculation is to be performed in accordance with the items. Alternatively the logical entity may notify the communication terminal 11 of the minimum assignment range that the logical entity wants the communication terminal 11 to perform calculation after determining each component that is in charge of the calculation, and the communication terminal 11 may expand the assignment range in accordance with the items. Alternatively the logical entity may notify the communication terminal 11 of the allowable assignment range (in other words, an upper limit of the assignment range) after determining each component that is in charge of the calculation, and the communication terminal 11 may reduce the assignment range indicated by the notification from the logical entity in accordance with the items.

In a case where the condition for determining the assignment range of the communication terminal 11 is held by the communication terminal 11 and the communication terminal 11 dynamically determines the assignment range, it is possible to determine the assignment range on the basis of resources at the timing at which the communication terminal 11 activates the ML application or the timing at which the ML application executes the calculation of the DNN. Therefore, it is possible to determine the assignment range of the communication terminal 11 that is more suitable for the state of the communication terminal 11. Also, in this case, it is possible to reduce the number of times of the periodic transmission of resources from the communication terminal 11 to the logical entity and the number of times of the notification regarding a change in assignment ranges from the logical entity to the communication terminal 11 and thereby to reduce the processing load of each entity and utilization of the communication resources.

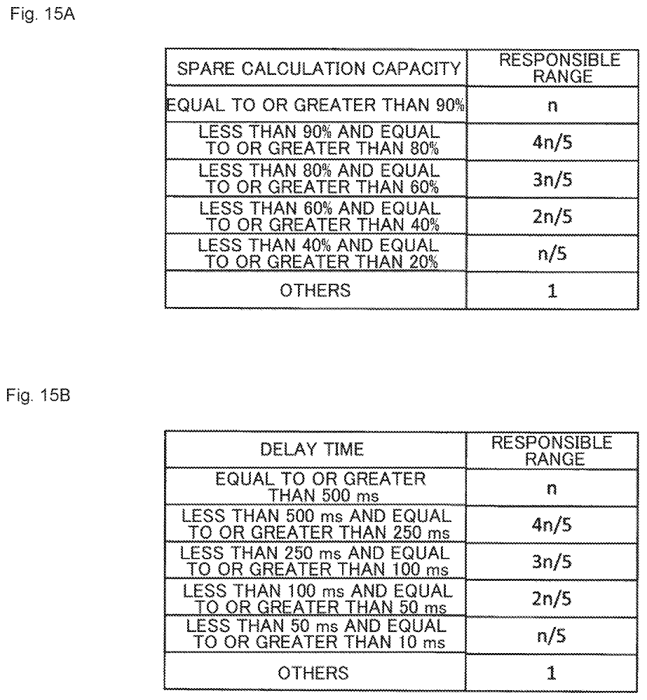

FIG. 15 is a diagram illustrating an example of the condition for determining the assignment range of the communication terminal 11. In the example in FIG. 15(A), the condition for determining the calculation range of the DNN on the basis of the spare calculation capacity of the communication terminal 11 is illustrated. The description that the assignment range is n in a case where the spare calculation capacity is equal to or greater than 90% in the example in FIG. 15(A), for example, indicates that the communication terminal 11 is in charge of the calculation from the first layer to the n-th layer in the DNN. Note that the example in FIG. 15 assumes that n is an integer that is equal to or greater than ten. Also, the n-th layer may be the final layer of the DNN or may be the final layer of the assignment range indicated by the notification from the logical entity. Also, the fact that the assignment range decreases as the spare calculation capacity decreases is illustrated. The example in FIG. 15(A) illustrates that the assignment range is up to the 4n/5-th layer in a case where the spare calculation capacity is less than 90% and equal to or greater than 80%, and the assignment range is reduced as compared with a case where the spare calculation capacity is equal to or greater than 90%. Similarly it illustrates that the assignment range is up to the 3n/5-th layer in a case where the spare calculation capacity is less than 80% and equal to or greater than 60%, illustrates that the assignment range is up to the 2n/5-th layer in a case where the spare calculation capacity is less than 60% and equal to or greater than 40%, and illustrates that the assignment range is up to the n/5-th layer in a case where the spare calculation capacity is less than 40% and equal to or greater than 20%. The assignment range of the communication terminal 11 may be determined in this manner. Also, it illustrates that the assignment range is up to the first layer in a case where the spare calculation capacity is outside the ranges, that is, less than 20%, and this means that the communication terminal 11 does not execute the calculation of the DNN. In other words, there may be a case where the communication terminal 11 refuses the calculation even in a case where the communication terminal 11 is designated as a component that is in charge of the calculation. The situation in which it takes time to perform calculation in the assignment range due to low spare calculation capacity of the communication terminal 11 may be prevented by reducing the assignment range in a case where the spare calculation capacity of the communication terminal 11 is low in this manner. Here, FLOPS (a product of the clock frequency and the number of arithmetic operations per clock) that is an absolute amount instead of the relative amount (%) may be used, or other values that can indicate the spare calculation capacity may be used as the spare calculation capacity.

In the example in FIG. 15(B), the assignment ranges are determined similarly to FIG. 15(A) while the conditions are on the basis of a delay time. Note that which of the communication destinations the delay time is to be considered may be defined in advance and is not particularly limited. It may be the next component that is in charge of the calculation, or may be the logical entity or the wireless communication node to which the communication terminal 11 establishes wireless connection. Alternatively since a main factor of the delay time is wireless processing performed by each entity, the time related to the wireless processing may be regarded as the delay time without considering wireless (radio waves) and wired propagation delays. In the example in FIG. 15(B), the communication terminal 11 is in charge of the calculation from the first layer to the n-th layer in the DNN in a case where the delay time is equal to or greater than 500 ms. Also, it illustrates that the assignment range is up to the 4n/5-th layer in a case where the delay time is less than 500 ms and equal to or greater than 250 ms, illustrates that the assignment range is up to the 3n/5-th layer in a case where the delay time is less than 250 ms and equal to or greater than 100 ms, illustrates that the assignment range is up to the 3n/5-th layer in a case where the delay time is less than 100 s and equal to or greater than 50 ms, illustrates that the assignment range is up to the 2n/5-th layer in a case where the delay time is less than 50 ms and equal to or greater than 10 ms, and illustrates that the communication terminal 11 does not execute the calculation of the DNN in a case where the delay time is outside the ranges, that is, less than 10 ms.

Note that although the assignment range of the communication terminal 11 uniformly increases with an increase in delay time in the example in FIG. 15(B), it is not necessary to uniformly increase the assignment range. As illustrated in FIG. 4, the data size of the calculation result does not uniformly decrease as the calculation of the DNN advances. Therefore, it is only necessary to determine a combination of a delay time and an assignment range in consideration of the data size of the calculation result of each layer with reference to data as in FIG. 4.

Also, such a condition may be appropriately set in accordance with the specification of the embodiment and is not particularly limited. For example, it is possible to change the condition for each type of the ML application. Additionally, a plurality of conditions may be provided, and change may be performed in a case where all the conditions are satisfied, or change may be performed in accordance with a condition with the highest priority from among the satisfied conditions.

Also, a confidentiality level may be defined in advance for each type of the ML application, and the assignment range of the communication terminal 11 may be set to the first layer to the second or higher layer in a case where the confidentiality level of the executed ML application is equal to or greater than a predetermined threshold value. In this manner, the communication terminal 11 does not transmit the input data of the DNN to the outside. It is thus possible to reduce the risk that the highly confidential information leaks to the outside of the communication terminal 11.

However, in a case where the communication terminal 11 determines the assignment range of the communication terminal 11 itself, the next component that is in charge of the calculation cannot recognize from which layer in the DNN the calculation is to be started. Therefore, although the logical entity notifies each component that is in charge of the calculation of the assignment range, for example, there is a concern that in a case where the communication terminal 11 changes the assignment range indicated by the notification from the logical entity, the next component that is in charge of the calculation inputs the calculation result from the communication terminal 11 to each node of the first layer in the scheduled assignment range of the component itself without knowing that the communication terminal 11 has changed the assignment ranges. Therefore, in the case where the communication terminal 11 determines or changes the assignment range of the communication terminal 11 itself, it is necessary for the communication terminal 11 to provide not only the calculation result but also a notification of information to identify the node from which the next component that is in charge of the calculation is to start the calculation. The information may be information indicating the final layer of the assignment range of the communication terminal 11, may be information indicating the first layer of the assignment range of the next component that is in charge of the calculation, may be information indicating the node that has output the calculation result, or may be information indicating the node to which the calculation result is to be input, for example. Note that the communication terminal 11 may transmit the information directly to the next component that is in charge of the calculation or may transmit the information to the next component that is in charge of the calculation via the logical entity.

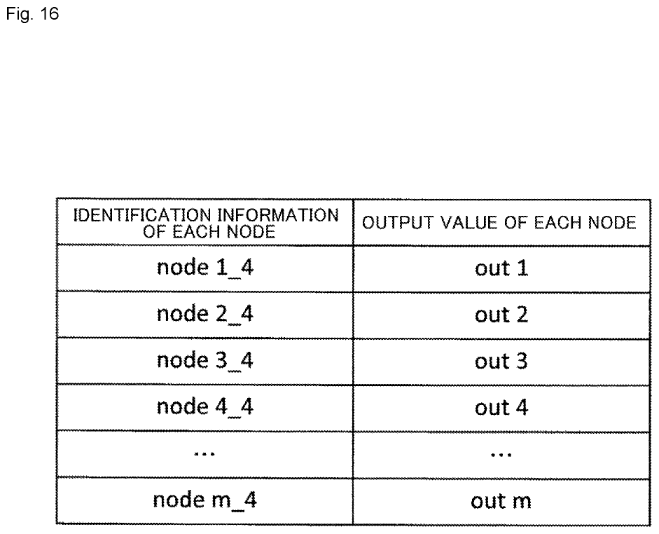

FIG. 16 is a diagram illustrating an example of the calculation result transmitted from the communication terminal 11 in a case where the communication terminal 11 determines the assignment range of the communication terminal 11 itself. In the example in FIG. 16, an output value of each node, which is a calculation result, and identification information for identifying the node that has output the output value are included. Note that although the identification information (identifier) of each node is described like a “node 3_4” in the example in FIG. 16, the number at the end indicates the number of the layer in which the node is included, and the number added right after “node” indicates the number of the node in the layer. In other words, “node 3_4” indicates the third node included in the fourth layer. Also, “out 3” described in the same row as that of “node 3_4” indicates an output value of the third node included in the fourth layer. Which of the nodes the output of each node is to be input can be recognized from the structure of the DNN and the like. It is only necessary for the next component that is in charge of the calculation and has received the information as in FIG. 16 to recognize, from the structure of the DNN and the like, the node to which the received output value is to be input and start the calculation.

Note that the above description has assumed that the components that are in charge of the calculation perform the calculation set for each node in the assignment ranges and transmit output values of the nodes belonging to the final layers in the assignment ranges to the next components that are in charge of the calculation. However, a plurality of calculating operations are typically set for each node of the DNN. Therefore, the component that is in charge of the calculation may perform some of the plurality of calculating operations set for the node, and the next component that is in charge of the calculation may perform the remaining calculation. In an example of calculation in each node, each input data item input to the node is multiplied by a weight coefficient set for a link, through which each piece of input data has passed, and is then added. Furthermore, a bias value set for each node is added to the added value. Then, the added value is input to a predetermined activation function, and an output from the activation function is an output value of the node. Therefore, a rule in which the component that is in charge of the calculation performs up to the calculation of the added value and the next component that is in charge of the calculation starts with the calculation of the activation function, for example, may be determined in advance, and the calculation may be assigned in such a manner. Note that the link connected to the node is also referred to as an edge.

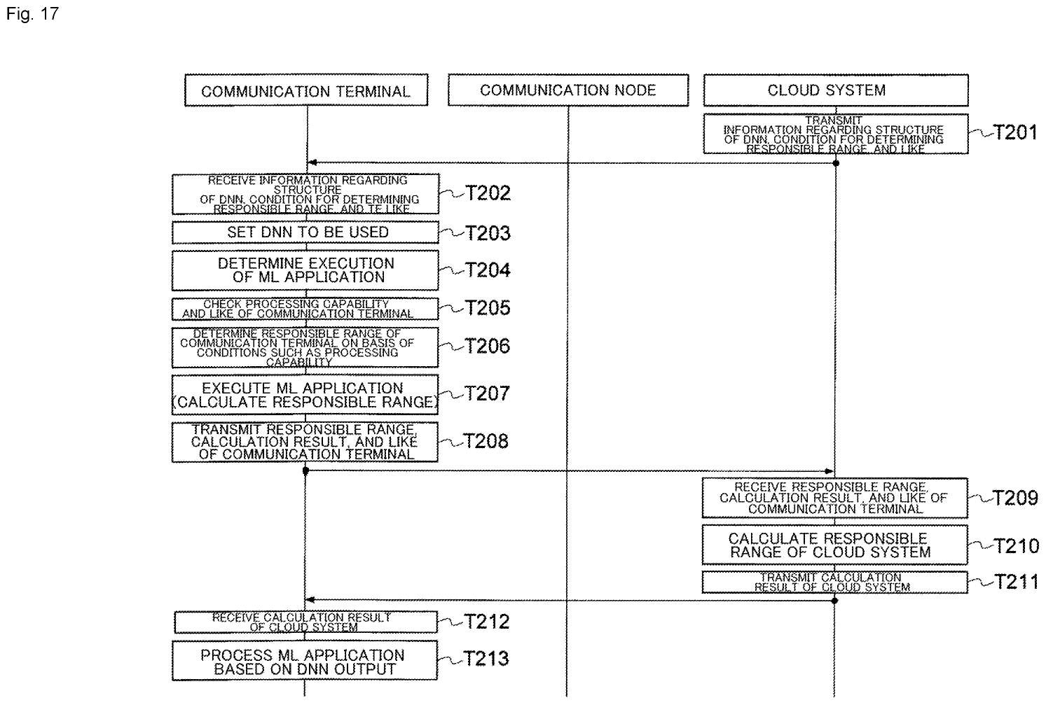

FIG. 17 is an overview sequence diagram illustrating a flow of overall processing in a case where the communication terminal 11 determines an assignment range of the communication terminal 11 itself. Note that in the example of this sequence diagram, the structure of the DNN used by the ML application, conditions for determining the assignment ranges for a series of calculation of the DNN, and the like are assumed to be managed by the cloud system 12. Also, although the components that are in charge of the calculation of the DNN are the communication terminal 11 and the cloud system 12 in the example of this sequence diagram, the communication terminal 11 and the communication nodes may be in charge of the calculation. Here, the functions of the core network 133 can be mounted in the cloud system 12. In other words, the core network 133 can manage the aforementioned conditions.

The cloud system 12 transmits information regarding the DNN used by the ML application, setting of the DNN, conditions for determining the assignment ranges, and the like (T201). The information is transferred via the communication nodes in the communication network 13, and the communication terminal 11 receives the information (T202) and performs setting for the ML application such as the DNN to be used on the basis of the information (T203).

Note that the communication nodes can detect that the communication terminal 11 has activated the ML application on the basis of 5G QoS identifier (5QI), single-network slice selection assistance information (S-NSSAI) or the like included in a connection request of the communication terminal 11, for example, a service request, or a protocol data unit (PDU) session establishment request. Therefore, the communication nodes may detect activation of the ML application achieved by the communication terminal 11 and notify the cloud system 12 of the fact that it has detected the activation, and the cloud system 12 may extract the DNN to be used by the detected ML application.

Thereafter, the communication terminal 11 determines execution of the ML application (T204). At that time, the communication terminal 11 checks processing capability of the communication terminal 11 itself (T205) and determines the assignment range of the communication terminal 11 on the basis of the conditions for determining the assignment range for the calculation of the DNN and the processing capability (T206). For example, in a case where the DNN is configured of ten layers under the conditions in the example illustrated in FIG. 15(A) for determining the assignment ranges of the DNN (in a case where n is 10), and if the spare calculation capacity is 50%, the communication terminal 11 determines that the layer to split the DNN is the fourth layer. Then, the communication terminal 11 executes the ML application and calculates the assignment range of the communication terminal 11 (T207). In the above example, calculation of the first layer to the fourth layer in the DNN is performed.

Note that the assignment ranges may be expanded again after the calculation of the assignment ranges. For example, whether or not a predetermined condition is satisfied may be checked after the calculation of the assignment ranges ends, and whether or not to continue the calculation in the next layer may be determined on the basis of the result of the checking. Here, whether or not the predetermined condition is satisfied may be determined on the basis of spare calculation capacity a delay time, a confidentiality level, and the like. In this manner, the assignment ranges may be determined a plurality of times.

The communication terminal 11 calculates the assignment range of the communication terminal 11 and then transmits information, from which it is possible to ascertain the assignment range and the calculation result of the communication terminal 11 as illustrated in FIG. 16, to the cloud system 12 via the communication nodes (T208). The cloud system 12 receives the information via the communication nodes (T209).

The cloud system 12 identifies a node that inputs a received output value, that is, each node of the next layer of the final layer of the assignment range of the communication terminal 11 on the basis of received identification information of each node, and calculates the assignment range of the cloud system 12 (T210). Then, after the calculation ends, the cloud system 12 replies the calculation result of the assignment range of the cloud system 12 to the communication terminal 11 (T211). Note that although the assignment range of the cloud system 12 assumes all the remaining calculation of the DNN, the assignment range may not be all the remaining calculation of the DNN. For example, the communication terminal 11 may receive the calculation result of the cloud system 12 and may further perform the remaining calculation of the DNN.

The communication terminal 11 receives the calculation result of the cloud system 12 via the communication nodes (T212). Then, the processing of the ML application is executed on the basis of the final calculation result (T213). In this manner, the processing of the ML application is completed. Note that an entity other than the communication terminal 11, such as the cloud system 12, may calculate up to the processing result of the ML application.

As described above, it is possible to more appropriately achieve distribution suitable for the conditions of the communication terminal by the communication terminal holding the conditions for determining the assignment ranges of the DNN and by the communication terminal determining the assignment range of the communication terminal itself in the case where the distributed learning of the DNN is performed among the entities. Additionally, it is also possible to prevent a situation such as leakage of input data from occurring by the communication terminal causing at least up to the second layer to perform the calculation of the DNN in accordance with the confidentiality level or the like of the ML application.

Note that typical algorithms used for deep learning include a convolution neural network (CNN), a recurrent neural network (RNN), long short-term memory (LSTM), and the like. In the CNN, a hidden layer is configured of layers which are called a convolution layer and a pooling layer. In the convolution layer, filtering based on a convolution arithmetic operation is performed, and data that is called a feature map is extracted. In the pooling layer, information of the feature map output from the convolution layer is compressed, and down sampling is performed thereon. In the RNN, a value of the hidden layer has a network structure that is recurrently input to the hidden layer, and for example, short-term time-series data is processed. In the LSTM, it is possible to hold an influence of output in the remote past by introducing parameters for holding states of intermediate layers that are called memory cells into an intermediate layer output of the RNN. In other words, longer-term time-series data than that in the RNN is processed in the LSTM. Examples of representative technical regions in which deep learning is used include four fields, namely image recognition, sound recognition, natural language processing, and robot abnormality detection. The image recognition is used for applications such as tagging of persons in social network services (SNS) and automatic driving. The sound recognition is applied to smart speakers and the like. The natural language processing is applied to browser searching and automatic translation. The robot abnormality detection is used in airports, trains, manufacturing sites, and the like.

The communication nodes in the communication network 13 will be described. As described above, the communication nodes are called communication base stations (also simply referred to as base stations) and are included in infrastructure for performing communication, and the infrastructure is also called a base station device. The base station device is also one type of communication device and is also called an information processing device. For example, the base station device may be a device that is for causing the communication node to function as wireless base stations (a base station, Node B, eNB, gNB, and the like), radio access points, and the like. Also, the base station device may be a device that causes the communication nodes to function as a donor station or a relay station. Additionally the base station device may be a light extension device that is called a remote radio head (RRH). Also, the base station device may be a device that causes the communication nodes to function as a reception station such as a field pickup unit (FPU). Moreover, the base station device may be a device that causes the communication nodes to function as an integrated access and backhaul (IAB) donor node that provides a radio access line and a radio backhaul line by time division multiplexing, frequency division multiplexing, or space division multiplexing or an IAB relay node. Also, the base station device may be configured of a plurality of devices and may be, for example, a combination of an antenna mounted in a structure such as a building and a signal processing device connected to the antenna.

Note that the radio access technology used by the base station device may be a cellular communication technology or a wireless LAN technology. It is a matter of course that the radio access technology used by the base station device is not limited thereto and may be another radio access technology. For example, the radio access technology used by the base station device may be a low power wide area (LPWA) communication technology. It is a matter of course that the wireless communication used by the base station device may be wireless communication using millimeter waves. Also, the wireless communication used by the base station device may be wireless communication using radio waves or may be wireless communication (optical wireless communication) using infrared light or visible light.

The base station device may be able to perform non-orthogonal multiple access (NOMA) communication with the communication terminal 11. Here, the NOMA communication is communication (transmission, reception or both) using non-orthogonal resources. Note that the base station device may be able to perform NOMA communication with other base station devices.

Note that the base station devices may be able to perform communication with each other via a base station-core network interface (for example, an S1 interface). The interface may be either a wired interface or a wireless interface. Also, the base station devices may be able to perform communication with each other via an inter-base station interface (for example, an X2 interface or an S1 interface). The interface may be either a wired interface or a wireless interface.

Note that the base station devices may be able to perform communication with each other via a base station-core network interface (for example, an NG interface or an S1 interface). The interface may be either a wired interface or a wireless interface. Also, the base station devices may be able to perform communication with each other via an inter-base station interface (for example, an Xn interface or an X2 interface). The interface may be either a wired interface or a wireless interface.

Also, the term “base station” may mean a structure including the function of the base station. The structure is not particularly limited. For example, buildings such as tall buildings, houses, steel towers, station facilities, airport facilities, port facilities, office buildings, school buildings, hospitals, factories, commercial facilities, and stadiums are also included in the structure. Also, structures (non-building structures) such as tunnels, bridges, dams, fences, and steel poles and facilities such as cranes, gates, and wind turbines are also included in the structure. Also, the location where the structure is placed is not particularly limited. In other words, not only structures on the land (on the ground in a narrow sense) or in the ground but also structures above water such as piers and megafloats and structures in water such as oceanographic platforms can also be the structures including the functions of the base station.

Also, the base station may be a fixed station or a moving station as described above. The base station may be caused to serve as a moving station by the base station device being mounted on a mobile body. Alternatively the base station device may have moving capability (mobility), and the base station may be caused to serve as a moving station by the base station device itself moving. Also, a device that originally has moving capability like a vehicle and an unmanned aerial vehicle (UAV), representative examples of which include a drone, and includes functions of the base station (at least some of the functions of the base station) mounted thereon can also be called a moving station or a base station device that serves as a moving station. Additionally, a device that is moved by being carried by a mobile body like a smartphone and that includes the functions of the base station (at least some of the functions of the base station) mounted thereon can also be called as a moving station or a base station device of the moving station.

The locations where the fixed station and the moving station are present are not particularly limited. Therefore, the mobile body configuring the moving station may be a mobile body moving on the land (on the ground in a narrow sense) (for example, a vehicle such as an automobile, a bicycle, a bus, a truck, a motorcycle, a train, or a linear motor car), a mobile body moving in the ground (for example, in tunnels) (for example, a subway), a mobile body moving above water (for example, ships such as a passenger ship, a cargo ship, or a hovercraft), a mobile body moving in water (for example, a submarine such as a submarine vessel, a submarine boat, or an unmanned submarine), a mobile body moving in the air such as in the aerospace (for example, aircraft such as an airplane, an airship, or a drone), or a mobile body capable of floating outside the aerospace, in other words, in the space (for example, an artificial astral body such as an artificial satellite, a space ship, a space station, or a probe). Note that the base station floating outside the aerospace is also referred to as a satellite station. On the other hand, the base station on a side closer to the Earth than the outside of the aerospace is also called a ground-based station. Also, the base station floating in the aerospace such as aircraft is also called an aircraft station.

Note that the satellite serving as the satellite station may be any of a low earth orbiting (LEO) satellite, a medium earth orbiting (MEO) satellite, a geostationary earth orbiting (GEO) satellite, and a highly elliptical orbiting (HEO) satellite.

Note that heavier-than-air aircraft such as an airplane or a glider, lighter-than-air aircraft such as a balloon or an airship, or an unmanned aerial vehicle such as a helicopter or a rotor craft drone of auto gyro or the like can be an aircraft station. Note that how to control the unmanned aircraft that can be an aircraft station is not particularly limited. In other words, examples of a control system for the unmanned aircraft include an unmanned aircraft system (UAS), a tethered UAS, a lighter-than-air UAS (LTA), a heavier-than-air UAS (HTA), and high altitude UAS platforms (HAPs), and flight of the aircraft station may be controlled by these control systems.

Also, the coverage size of the base station device is not particularly limited, may be large like a macrocell, may be small like a picocell, or may be very small like a femtocell. Also, the base station device may have beam forming capability. In this case, a cell and a service area may be formed for each beam for the base station device. To do so, the base station device may include an antenna array configured of a plurality of antenna elements to provide advanced antenna technologies, representative examples of which include multiple input multiple output (MIMO) and beam forming.

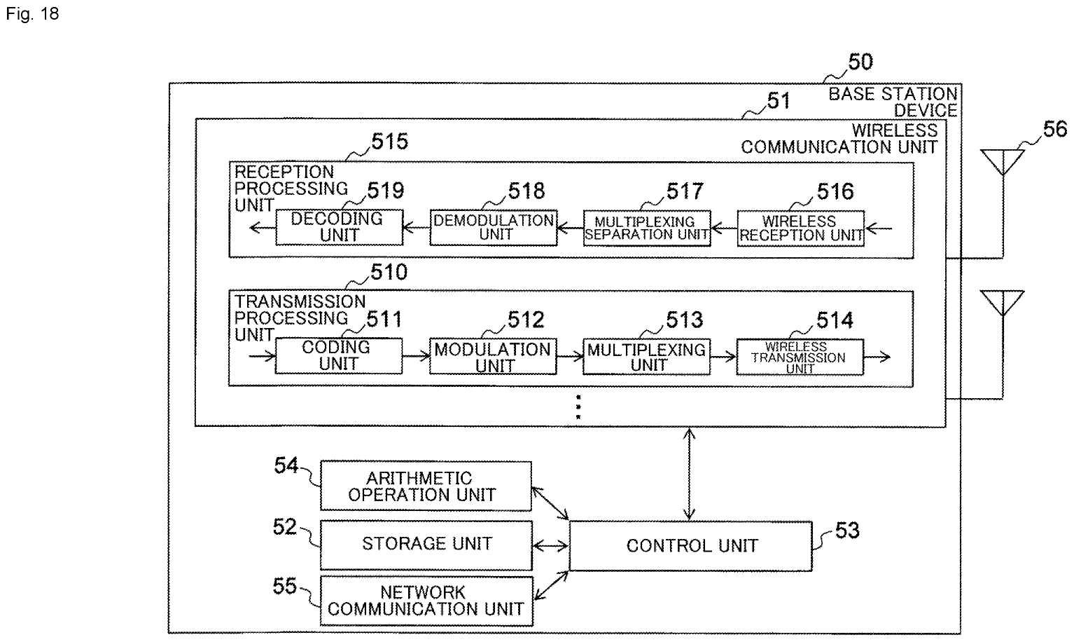

FIG. 18 is a diagram illustrating a configuration example of the base station device. The base station device 50 illustrated in FIG. 18 is assumed to perform wireless communication and includes a wireless communication unit 51, a storage unit 52, a control unit 53, an arithmetic operation unit 54, a network communication unit 55, and an antenna 56. Note that the configuration illustrated in FIG. 18 is a functional configuration and may be different from a hardware configuration. Also, components in FIG. 18 may be further distributed or may be integrated with other components. Additionally the components in FIG. 18 may be independently present as devices that are different from the base station device 50, and a plurality of devices may realize the functions of the base station device 50.

The wireless communication unit 51 performs signal processing for establishing wireless communication with other wireless communication devices (for example, the communication terminal 11). The wireless communication unit 51 operates in accordance with control performed by the control unit 53. The wireless communication unit 51 is compatible with one or more radio access schemes.

For example, the wireless communication unit 51 is compatible with both the New Radio (NR) scheme and the Long Term Evolution (LTE) scheme. The wireless communication unit 51 may be compatible with a Wideband Code Division Multiple Access (W-CDMA) or Code Division Multiple Access 2000 (CDMA2000) in addition to the NR and the LTE. In addition, the wireless communication unit 51 may be compatible with automatic retransmission techniques such as Hybrid Automatic Repeat reQuest (HARQ).

The wireless communication unit 51 includes a transmission processing unit 510 and a reception processing unit 515. The wireless communication unit 51 may include a plurality of transmission processing units 510 and a plurality of reception processing units 515. Note that in a case where the wireless communication unit 51 is compatible with a plurality of radio access schemes, each component of the wireless communication unit 51 may be individually configured for each radio access scheme. For example, the transmission processing unit 510 and the reception processing unit 515 may be individually configured for each of the LTE and the NR. Also, the number of antennas 56 may be one or more, and each antenna 56 may be configured of a plurality of antenna elements (for example, a plurality of patch antennas). In this case, the wireless communication unit 51 may be configured to enable beam forming. The wireless communication unit 51 may be configured to enable polarized beam forming using vertical polarization (V polarization) and horizontal polarization (H polarization).

The transmission processing unit 510 performs transmission processing of downlink control information and downlink data. For example, a coding unit 511 of the transmission processing unit 510 codes the downlink control information and the downlink data input from the control unit 53 by using a coding scheme such as block coding, convolution coding, or turbo coding. Here, coding based on a polar code or coding based on a low density parity check code (LDPC) may be performed as the coding.

Then, a modulation unit 512 of the transmission processing unit 510 modulates coding bits by a predetermined modulation scheme such as binary phase shift keying (BPSK), quadrature phase shift keying (QPSK), quadrature amplitude modulation (16QAM), 64QAM, or 256QAM. In this case, signal points on constellation of the modulation scheme may not necessarily be at equal distances. The constellation may be non uniform constellation (NUC).

Then, a multiplexing unit 513 of the transmission processing unit 510 multiplexes a modulation symbol of each channel used for transmission and a downlink reference signal and arrange them to a predetermined resource element.

Furthermore, the transmission processing unit 510 performs various kinds of signal processing on the multiplexed signal. For example, a wireless transmission unit 514 of the transmission processing unit 510 performs conversion into a frequency domain through fast Fourier transform, addition of a guard interval (cyclic prefix), generation of a baseband digital signal, conversion into an analog signal, orthogonal modulation, up-converting, removal of excess frequency components, and amplification of power. The signal generated by the wireless transmission unit 514 is transmitted from the antenna 56.

The reception processing unit 515 performs processing on an uplink signal received via the antenna 56. For example, a wireless reception unit 516 of the reception processing unit 515 performs, on the uplink signal, down-converting, removal of unnecessary frequency components, amplification level control, orthogonal demodulation, conversion into a digital signal, removal of the guard interval (cyclic prefix), and extraction of a frequency domain signal through fast Fourier transform.

Then, a multiplexing separation unit 517 of the reception processing unit 515 separates an uplink channel, such as a physical uplink shared channel (PUSCH) and a physical uplink control channel (PUCCH), and an uplink reference signal from the signal on which the processing has been performed by the wireless reception unit 516.

Also, a demodulation unit 518 of the of the reception processing unit 515 demodulates the reception signal by using a modulation scheme such as BPSK or QPSK for a modulation symbol of the uplink channel. The modulation scheme used for the demodulation may be 16QAM, 64QAM, or 256QAM. In this case, the signal points on the constellation may not be at equal distances. The constellation may be non uniform constellation (NUC).

Then, a decoding unit 519 of the reception processing unit 515 performs decoding processing on a coding bit of the demodulated uplink channel. The decoded uplink data and uplink control information are output to the control unit 53.

The antenna 56 performs conversion between a current and radio waves. The antenna 56 may be configured of one antenna element (for example, one patch antenna) or may be configured of a plurality of antenna elements (for example, a plurality of patch antennas). In a case where the antenna 56 is configured of a plurality of antenna elements, the wireless communication unit 51 may be configured to enable beam forming. For example, the wireless communication unit 51 may be configured to generate a directional beam by controlling directionality of a wireless signal by using the plurality of antenna elements. Note that the antenna 56 may be a dual polarization antenna. In the case where the antenna 56 is a dual polarization antenna, the wireless communication unit 51 may use vertical polarization (V polarization) and horizontal polarization (H polarization) to transmit the wireless signal. Then, the wireless communication unit 51 may control directionality of the wireless signal transmitted by using the vertical polarization and the horizontal polarization.

The storage unit 52 serves as a storage means of the base station device 50 and stores information necessary for the processing of the base station device 50, processing results, and the like. For example, various programs for the base station device 50 to perform the processing may be stored therein.

The control unit 53 controls each part of the base station device 50. For example, the control unit 53 performs control necessary to acquire, from the outside, information related to the DNN used by the logical entity or the like, conditions to determine the assignment ranges for the series of calculation of the DNN, and the like via the wireless communication unit 51 or the network communication unit 55.

The arithmetic operation unit 54 performs an arithmetic operation necessary for the base station device 50 to perform the processing in accordance with an instruction from the control unit 53. For example, the arithmetic operation unit 54 may perform a part of the processing performed by the transmission processing unit 510 and the reception processing unit 515, for example, an arithmetic operation requiring a high load instead. Also, in a case where the base station device is a component that is in charge of the calculation, for example, the calculation of the assignment range for the base station device may be performed by the arithmetic operation unit 54. Additionally, in a case where the base station device 50 is a logical entity, for example, the arithmetic operation unit 54 may perform the processing executed by the logical entity, for example, determination of the components that are in charge of the calculation on the basis of the resources, determination of the assignment ranges, and the like.

The network communication unit 55 performs signal processing for establishing wired communication with other communication devices (for example, the cloud system 12). For example, for example, the network communication unit 55 is connected to an access and mobility management function (AMF) or a user plane function (UPF) of the core network and exchanges information and signaling.

In some embodiments, the base station device may be configured of a plurality of physical or logical devices. For example, the base station device may be divided into a plurality of devices such as a baseband unit (BBU) and a radio unit (RU) in the present embodiment. Then, the base station device may be interpreted as a group of these plurality of devices, in other words, as a base station system. Also, the base station device may be any one of the BBU and the RU or may be the both. The BBU and the RU may be connected by a predetermined interface such as an enhanced common public radio interface (eCPRI). Note that the RU may be referred to as a remote radio unit (RRU) or a radio dot (RD) instead. Moreover, the RU may be compatible with a gNB distributed unit (gNB-DU), which will be described later. Furthermore, the BBU may be compatible with a gNB central unit (gNB-CU). Additionally the RU may be a device formed integrally with an antenna. The antenna included in the base station device (for example, the antenna formed integrally with the RU) may employ an advanced antenna system and support MIMO (for example, FD-MIMO) or beam forming. Also, the antenna included in the base station may include sixty four transmission antenna ports and sixty four reception antenna ports, for example.

Also, the number of antennas attached to the RU may be one or more, and each antenna may be an antenna panel configured of one or more antenna elements. For example, antenna panels including two types of antenna panels, namely a horizontal polarization antenna panel and a vertical polarization antenna panel or antenna panels including two types of antenna panels, namely a right-handed circular polarization antenna panel and a left-handed circular polarization antenna panel may be mounted on the RU. Also, the RU may form independent beams for each antenna panel and control them.

Note that the base station of the radio access network (RAN) may be referred to as an RAN node while a base station of the access network (AN) may be referred to as an AN node. Note that the RAN in the LTE may be referred to as an enhanced universal terrestrial RAN (E-UTRAN). Also, the RAN in the NR may be referred to as NG-RAN. Furthermore, the RAN in W-CDMA (UMTS) may be referred to as UTRAN.

Note that the base station of the LTE is referred to as an evolved node B (eNodeB) or eNB, and at this time, it is possible to state that E-UTRAN includes one or more eNodeB (eNB) components. Also, the base station of the NR is also referred to as gNodeB or gNB, and at this time, it is possible to state that NG-RAN includes one or more gNB components. E-UTRAN may include gNB (en-gNB) connected to the core network (EPC) in the LTE communication system (EPS). Similarly NG-RAN may include ng-eNB connected to the core network 5GC in the 5G communication system (5GS).

Note that in a case where the base station is eNB, gNB, or the like, the base station may be referred to as a 3GPP access. Also, in a case where the base station is a radio access point, the base station may be referred to as a non-3GPP access. Additionally, in a case where the base station is gNB, the base station may be a combination of gNB-CU and gNB-DU as described above or may be any one of gNB-CU and gNB-DU.

Here, gNB-CU hosts a plurality of higher order layers (for example, RRC, SDAP, PDCP) from among the access stratum for communication with the UE. On the other hand, gNB-DU hosts a plurality of lower order layers (for example, RLC, MAC, PHY) from among the access stratum. In other words, RRC signaling (quasistatic notification) among messages or information such as RRC signaling, a MAC control element (MAC CE), and DCI may be generated by gNB-CU while MAC CE and DCI (dynamic notification) may be generated by gNB-DU. Alternatively, some configurations such as IE:cellGroupConfig, for example, among RRC configurations (quasistatic notification) may be generated by gNB-DU while the remaining configurations may be generated by gNB-CU. These configurations may be transmitted and received by an F1 interface, which will be described alter.

Note that the base station may be configured to be able to perform communication with other base stations. In a case where the plurality of base stations are only eNB components or a combination of eNB and en-gNB, for example, the base stations may be connected by an X2 interface. Also, in a case where the plurality of base stations are only gNB components or a combination of gn-eNB and gNB, the devices may be connected by an Xn interface. Additionally, in a case where the plurality of base stations are a combination of gNB-CU and gNB-DU, the devices may be connected by the F1 interface described above. The messages or information such as RRC signaling, MAC CE, and DCI may be transmitted among the plurality of base stations via the X2 interface, the Xn interface, or the F1 interface, for example.

The cells provided by the base station may be referred to as serving cells. The concept of the serving cells includes a primary cell (PCell) and secondary cells (SCells). In a case where the dual connectivity is set in the UE, the PCell provided by a master node (MN) and zero or one or more SCells may be referred to as a master cell group. Examples of the dual connectivity include E-UTRA-E-UTRA dual connectivity E-UTRA-NR dual connectivity (ENDC), E-UTRA-NR dual connectivity with 5GC, NR-E-UTRA dual connectivity (NEDC), and NR-NR dual connectivity.

Note that the serving cells may include a primary secondary cell (PSCell or primary SCG cell). In a case where dual connectivity is set in the UE, the PSCell provided by a secondary node (SN) and zero or one or more SCells may be referred to as a secondary cell group (SCG). Unless special setting (for example, PUCCH on the SCell) is adopted, a physical uplink control channel (PUCCH) is transmitted by the PCell or the PSCell while it is not transmitted by the SCell. Also, a radio link failure is detected by the PCell and the PSCell while it is not detected by the SCell (it may not be detected). Since the PCell and the PSCell play special roles from among the serving cells, they are also referred to as special cells (SpCells).

One downlink component carrier and one uplink component carrier may be associated with one cell. Also, the system bandwidth corresponding to one cell may be split into a plurality of bandwidth parts (BWPs). In this case, one or more BWPs are set in the UE, and one BWP may be used as an active BWP by the UE. Also, radio resources (for example, a frequency band, numerology (sub-carrier spacing), slot format (slot configuration)) that can be used by the UE may differ for each cell, for each component carrier, or each BWP.

The communication terminal 11 will be additionally described. The communication terminal 11 may be moved by being mounted on a mobile body or may be a mobile body itself. For example, the communication terminal 11 may be a vehicle moving on a road, such as an automobile, a bus, a truck, or a motorcycle or may be a vehicle moving on a rail installed along a track such as a train or a wireless communication device mounted on the vehicle. Note that the mobile body may be a mobile terminal or may be a mobile body that moves on the land (on the ground in a narrow sense), in the ground, above water, or in water. Also, the mobile body may be a mobile body moving in an aerospace such as a drone or a helicopter or may be a mobile body moving outside the aerospace such as an artificial satellite. Also, main applications of the communication terminal 11 are not limited as long as the communication terminal 11 has an information processing function and a communication function and is a device capable of performing the processing according to the present disclosure. For example, the communication terminal 11 may be a device such as a professional camera having an information processing function and a communication function or may be a communication device such as a field pickup unit (FPU). Also, the communication terminal 11 may be a machine-to-machine (M2M) device or an Internet-of-Things (IoT) device.

Note that the communication terminal 11 may be able to perform NOMA communication with the base station. Also, the communication terminal 11 may be able to use automatic retransmission technologies such as HARQ when it communicates with the base station. The communication terminal 11 may be able to perform sidelink communication with other communication terminals 11. The communication terminal 11 may be able to use the automatic retransmission technologies such as HARQ when it performs sidelink communication as well. Note that the communication terminal 11 may be able to perform NOMA communication even in communication (sidelink) with other communication terminals 11. Additionally the communication terminal 11 may be able to perform LPWA communication with other communication devices (for example, the base station, other communication terminals 11). Also, the wireless communication used by the communication terminal 11 may be wireless communication using millimeter waves. Note that the wireless communication (including sidelink communication) used by the communication terminal 11 may be wireless communication using radio waves or may be wireless communication (optical wireless communication) using infrared light or visible light.

The communication terminal 11 may be a communication device mounted on a mobile body or may be a communication device with moving capability. For example, the mobile body with the communication terminal 11 mounted thereon may be a vehicle moving on a road, such as an automobile, a bus, a truck, or a motorcycle or may be a vehicle moving on a rail installed along a track such as a train. Note that the location to which the mobile body moves is not particularly limited. Therefore, the mobile body may be a mobile body that moves on the land (on the ground in a narrow sense), in the ground, above water, or in water. Also, the mobile body may be a mobile body moving in an aerospace such as a drone or a helicopter or may be a mobile body moving outside the aerospace such as an artificial satellite.

The communication terminal 11 may be connected to a plurality of base stations or a plurality of cells at the same time and perform communication therewith. In a case where one base station supports a communication area via a plurality of cells (for example, pCell, sCell), for example, it is possible to tie up the plurality of cells and establish communication between the base station and the communication terminal 11 by a carrier aggregation (CA) technology a dual connectivity (DC) technology or multi-connectivity (MC) technology. Alternatively it is possible to establish communication between the communication terminal 11 and a plurality of base stations via cells of different base stations by coordinated multi-point transmission and reception (CoMP) technology.

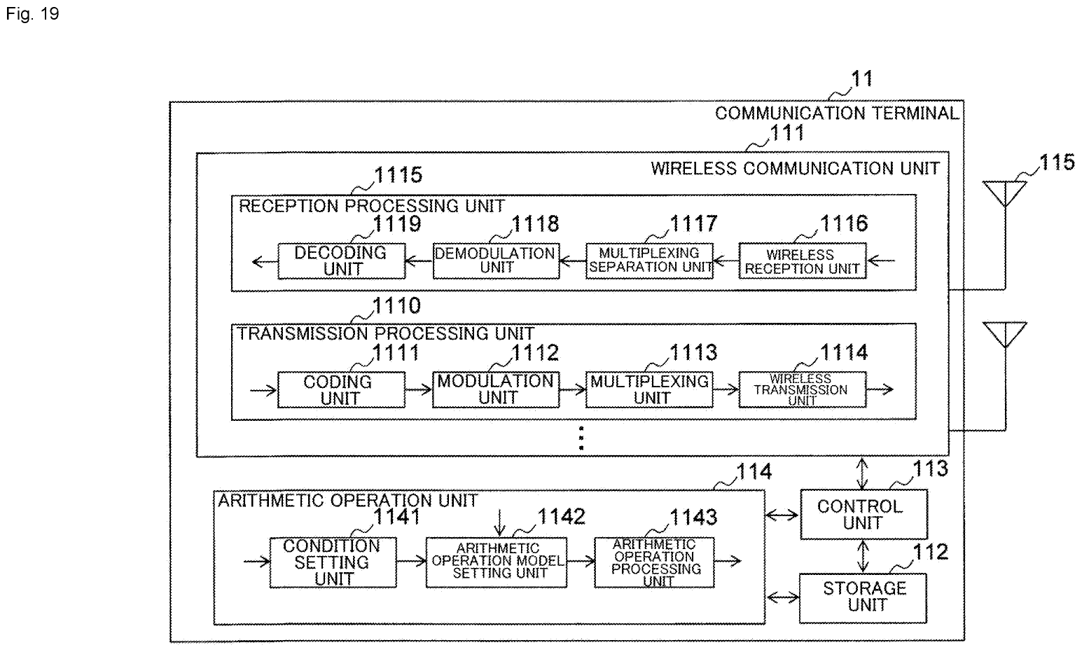

FIG. 19 is a diagram illustrating a configuration example of the communication terminal 11. FIG. 19 is a configuration example in a case where wireless communication is performed, and the communication terminal 11 includes a wireless communication unit 111, a storage unit 112, a control unit 113, an arithmetic operation unit 114, and an antenna 115. Note that the configuration illustrated in FIG. 19 is a functional configuration and may be different from a hardware configuration. Additionally, the functions of the communication terminal 11 may be mounted on a plurality of physically separated components in a distributed manner.

The wireless communication unit 111 performs signal processing to perform wireless communication with other wireless communication devices (for example, the base station, the relay station, the wireless communication nodes 131, the donor nodes 132, other communication terminals 11, and the like). The wireless communication unit 111 operates in accordance with control performed by the control unit 113. The wireless communication unit 111 includes a transmission processing unit 1110 and a reception processing unit 1115. The components related to the wireless communication of the communication terminal 11 may be similar to the corresponding components related to the wireless communication of the base station device 50. In other words, the configurations of the wireless communication unit 111 and the internal components thereof and of the antenna 115 may be similar to those of the wireless communication unit 51 and internal components thereof in the base station device 50 and of the antenna 56, respectively. Also, the wireless communication unit 111 may be configured to be able to perform beam forming similarly to the wireless communication unit 51 of the base station device 50.

The storage unit 112 serves as a storage means of the communication terminal 11 and stores information necessary to perform the processing of the communication terminal 11, processing results, and the like. For example, various programs to perform the processing of the communication terminal 11 may be stored therein.

The control unit 113 controls each part of the communication terminal 11. For example, the control unit 113 performs control necessary to acquire, from the outside, information regarding the DNN used by the logical entity or the like, conditions to determine the assignment ranges of the series of calculation of the DNN and the like via the wireless communication unit 111.

The arithmetic operation unit 114 performs arithmetic operations necessary to perform the processing of the communication terminal 11 in accordance with instructions from the control unit 113. For example, a part of the processing performed by the transmission processing unit 1110 and the reception processing unit 1115, for example, arithmetic operations requiring large loads may be performed by the arithmetic operation unit 114 instead. Also, the arithmetic operation unit 114 performs arithmetic operations necessary for the ML application executed by the communication terminal 11, such as calculation of the DNN, for example.

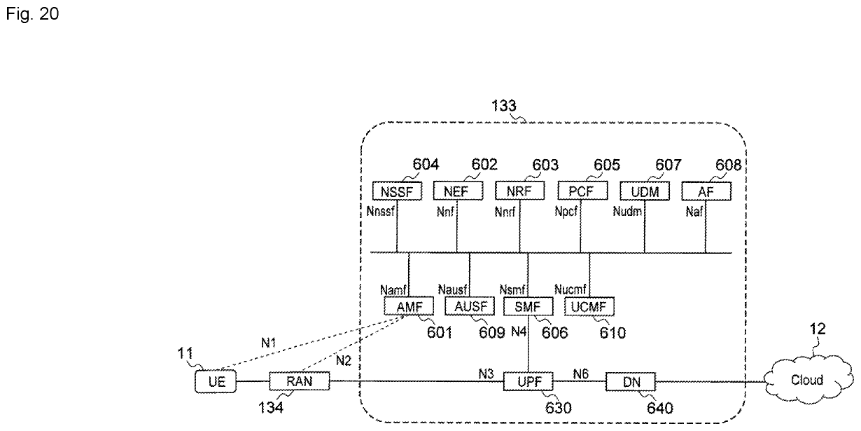

The core network will be additionally described. FIG. 20 is a diagram illustrating a configuration example of a network architecture of a 5G system (5GS) including the core network 133. In the example in FIG. 20, the 5GS is configured of the communication terminal 11 (illustrated as UE in FIG. 20), the RAN 134, and the core network 133. The RAN 134 provides a network function (NF) like the wireless communication nodes 131 and the donor node 132 in FIG. 1. The core network 133 in the 5GS is called a next generation core (NGC), a 5G core (5GC), or the like.

In the example in FIG. 20, a functional group of a control plane of the core network 133 is configured of a plurality of NFs, namely an access and mobility management function (AMF) 601, a network exposure function (NEF) 602, a network repository function (NRF) 603, a network slice selection function (NSSF) 604, a policy control function (PCF) 605, a session management function (SMF) 606, a unified data management (UDM) 607, an application function (AF) 608, an authentication server function (AUSF) 609, and a UE radio capability management function (UCMF) 610.

The UDM 607 performs maintaining, managing, processing, and the like of subscriber information. Note that an execution unit that maintains and manages the subscriber information is also referred to as a unified data repository (UDR) and may be separated from a front end (FE) that is an execution unit of the processing of the subscriber information. Also, the AMF 601 performs mobility management. The SMF 606 performs session management. The UCMF 610 maintains UE radio capability information corresponding to all UE radio capability IDs in a public land mobile network (PLMN). The UCMF 610 plays a role in assigning each PLMN-assigned UE radio capability ID.

FIG. 20 illustrates a service-based interface of the NF. Namf is a service-based interface provided by the AMF 601, Nsmf is a service-based interface provided by the SMF 606, Nnef is a service-based interface provided by the NEF 602, Npcf is a service-based interface provided by the PCF 605, Nudm is a service-based interface provided by the UDM 607, Naf is a service-based interface provided by the AF 608, Nnrf is a service-based interface provided by the NRF 603, Nnssf is a service-based interface provided by the NSSF 604, and Nausf is a service-based interface provided by the AUSF 609. Each NF exchanges information with other NFs via each service-based interface.

Also, a user plane function (UPF) 630 executes user plane processing. A data network (DN) 640 enables connection to services unique to a mobile network operator (MNO), the Internet, and services of third parties.

The RAN 134 establishes communication connection to the core network 133, the communication terminal 11, and the like. Note that the RAN 134 may establish communication connection to other communication networks, which are not illustrated, for example, an access network (NW). The RAN 134 includes a base station that is called gNB or ng-eNB. The RAN may be referred to as a next generation (NG)-RAN.

Information is exchanged between the UE 10 and the AMF 601 via a reference point N1. Information is exchanged between the RAN 134 and the AMF 601 via a reference point N2. Information is exchanged between the SMF 606 and the UPF 630 via a reference point N4.

Note that communication quality may be indicated by, for example, a delay time in transmission and reception, a data rate, a channel occupancy ratio, or the like. The channel occupancy ratio may be indicated by a channel busy ratio (CBR), a resource use rate, or a congestion level. For example, the CBR may be indicated by a proportion of wireless resources that are being used with respect to all available resources. Also, the congestion level may be indicated by a ratio of a received signal strength indicator (RRSI) that is entire reception power in a band with respect to a reference signal received power (RSRP) that is reception intensity of a reference signal. In addition, the congestion level may be indicated by a reciprocal number of reference signal received quality (RSRQ) that is reception quality of the reference signal.

Note that the processing according to the present disclosure is not limited to a specific standard, and the illustrated setting may be appropriately changed. It should be noted that the above-described embodiments show examples for embodying the present disclosure, and the present disclosure can be implemented in various other forms. For example, various modifications, substitutions, omissions, or combinations thereof are possible without departing from the gist of the present disclosure. Such forms of modifications, substitutions, and omissions are included in the scope of the invention described in the claims and the scope of equivalence thereof, as included in the scope of the present disclosure.

Also, the procedure for the processing described in the present disclosure may be regarded as a method including such a series of procedures. Alternatively the procedure may be regarded as a program for causing a computer to perform such a series of procedures or a recording medium that stores the program. Additionally, the processing of the logical entity and the components that are in charge of the calculation as described above are executed by a processor such as a CPU of the computer. Also, since the type of the recording medium does not affect the embodiments of the present disclosure, the type is not particularly limited.

Note that each component illustrated in FIGS. 18 to 20 and described in the present disclosure may be realized by software or may be realized by hardware. For example, each component may be a software module that is realized by software such as a micro program, and each component may be realized by a processor executing the software module. Alternatively each component may be realized by a circuit block on a semiconductor chip (die), for example, an integrated circuit such as an application specific integrated circuit (ASIC) or a field programmable gate array (FPGA). Also, the number of components and the number of pieces of hardware that realizes the components may not be the same. For example, one processor or circuit may realize a plurality of components. Conversely one component may be realized by a plurality of processors or circuits.

Note that the type of the processor described in the present disclosure is not limited. For example, it may be a CPU, a micro processing unit (MPU), a graphics processing unit (GPU), or the like.

Also, it is only necessary for the components for storing data, such as the storage unit 52 of the base station device 50 and the storage unit 112 of the communication terminal 11 to be realized by data readable/writable devices, and the devices may be appropriately selected. For example, the devices may be DRAMs, SRAMs, flash memories, hard disks, or the like.

The present disclosure may have the following configurations.

[1]

An information processing device that receives information regarding resources of a communication network that relays communication between a communication terminal that transmits an input to a deep neural network or is in charge of at least a part of a series of calculation of the deep neural network and transmits a result of the calculation and a server that is able to be in charge of at least a part of the series of calculation, and
determines an entity to which the series of calculation is assigned from among the communication terminal, the server, and communication nodes in the communication network on the basis of the information regarding the resources.

[2]

The information processing device according to [1], in which at least one of the communication nodes is determined as the entity to which the series of calculation is assigned.

[3]

The information processing device according to [1] or [2], in which a calculation range of which the entity with the series of calculation assigned thereto is in charge is determined on the basis of the information regarding the resources.

[4]

The information processing device according to [2] or [3] according to [2], in which at least one of the communication nodes that are present on a communication route between the communication terminal and the server is determined as the entity to which the series of calculation is assigned.

[5]

The information processing device according to any one of [2] to [4], in which the resources include communication capacity or communication quality of a communication link in the communication network, and
at least one of the communication nodes is determined as the entity to which the series of calculation is assigned on the basis of the communication capacity or the communication quality.

[6]

The information processing device according to [5], in which a communication time in which the result of the calculation performed by the communication node is transmitted via the communication link is estimated on the basis of the communication capacity or the communication quality, and at least one of the communication nodes is determined as the entity to which the series of calculation is assigned on the basis of the communication time.

[7]

The information processing device according to any one of [2] to [6], in which the resources include spare calculation capacity of the communication nodes, and at least one of the communication nodes is determined as the entity to which the series of calculation is assigned on the basis of the spare calculation capacity of the communication nodes.

[8]

The information processing device according to [7], in which calculation times required by the communication nodes to perform the calculation are estimated on the basis of the spare calculation capacity of the communication nodes, and at least one of the communication nodes is determined as an entity to which the series of calculation is assigned on the basis of the calculation times.

[9]

The information processing device according to any one of [2] to [8], in which the resources include communication capacity or communication quality of a communication link in the communication network and spare calculation capacity of the communication nodes,
communication times in which the result of the calculation performed by the communication nodes are transmitted via the communication link are estimated on the basis of the communication capacity or the communication quality,
calculation times required by the communication nodes to perform calculation are estimated on the basis of the spare calculation capacity of the communication nodes, and
at least one of the communication nodes is determined as the entity to which the series of calculation is assigned on the basis of a condition that a sum of the communication time and the calculation time does not exceed a predetermined threshold value.

[10]

The information processing device according to [4] or any one of [5] to [9] according to [4], in which the information processing device further receives information regarding a position of the communication terminal, and
the entity to which the series of calculation is assigned is changed in response to a change in the communication route accompanying movement of the communication terminal.

[11]

The information processing device according to [4] or any one of [5] to [10] according to [4], in which the information processing device further receives information regarding a topology of the communication network, and
the entity to which the series of calculation is assigned is changed in response to a change in the communication route accompanying a change in the topology.

[12]

The information processing device according to [3] or any one of [4] to [11] according to [3], in which the calculation range of which the entity with the series of calculation assigned thereto is in charge is determined by selecting one of a plurality of splitting modes on the basis of the resources.

[13]

The information processing device according to [12], in which the resources include a position of the communication terminal, and
the splitting modes are recreated when no predetermined communication nodes are present on the communication route changed with movement of the communication terminal.

[14]

The information processing device according to [3] or any one of [4] to [13] according to [3], in which the calculation range of which the entity with the series of calculation assigned thereto is in charge is changed by increasing or decreasing the calculation range of which the entity with the series of calculation assigned thereto is in charge on the basis of variations in the resources.

[15]

The information processing device according to [3] or any one of [4] to [11] according to [3], in which the calculation range is transmitted to the communication node determined as the entity to which the series of calculation is assigned.

[16]

The information processing device according to [15], in which a setting value for improving quality of a wireless communication link on the communication route is determined, and
the setting value for improving the quality of the wireless communication link on the communication route is transmitted to the communication nodes that are present on the communication route.

[17]

An information processing device that receives a part of a series of calculation based on a deep neural network as an assigned calculation range, performs calculation of the calculation range,
transmits a calculation result of the calculation range to a designated destination,
acquires information regarding spare calculation capacity or communication capacity or communication quality of a communication link through which the calculation result is transmitted,
transmits the acquired information to a designation source of the calculation range, and
receives information regarding a change in the calculation range from the designation source.

[18]

The information processing device according to [17], in which the information regarding the change in the calculation range is information indicating one of a plurality of splitting modes.

[19]

The information processing device according to [18], in which in a case where the calculation result satisfies a condition for ending the series of calculation in the middle, the calculation result is transmitted to a final reception destination of the calculation result of the series of calculation rather than the designated destination.

[20]

An information processing method including the steps of: receiving information regarding resources of a communication network that relays communication between a communication terminal that transmits an input to a deep neural network or is in charge of at least a part of a series of calculation of the deep neural network and transmits a result of the calculation and a server that is able to be in charge of at least a part of the series of calculation; and
determining a plurality of entities to which the series of calculation is assigned from among the communication terminal, the server, and communication nodes in the communication network on the basis of the information regarding the resources.

[21]

An information processing system including: a plurality of communication nodes that belong to a communication network that relays communication between a communication terminal that transmits an input to a deep neural network or is in charge of at least a part of a series of calculation of the deep neural network and transmits a result of the calculation and a server that is able to be in charge of at least a part of the series of calculation,
in which the plurality of communication nodes transmit information regarding resources of the communication network to a predetermined communication node from among the plurality of communication nodes, and
the predetermined communication node
receives the information regarding the resources, and determines a plurality of entities to which the series of calculation is assigned from among the communication terminal, the server, and the communication nodes on the basis of the information regarding the resources.

[22]

An information processing method including the steps of: determining a first assignment range of a series of calculation of a deep neural network; executing calculation of the first assignment range;
transmitting first information including identification information and an output value of a node included in a final layer in the first assignment range as a result of the calculation of the first assignment range;
receiving the first information;
identifying a node to which the output value included in the first information is to be input on the basis of the identification information included in the first information; and
executing remaining calculation of the deep neural network or calculation of a second assignment range by inputting the output value included in the first information to the identified node.

[23]

The information processing method according to [22], further including the step of: replying with a result of the remaining calculation of the deep neural network or the calculation of the second assignment range to a transmission source of the result of the calculation of the first assignment range.

[24]

The information processing method according to [22] or [23], further comprising the step of: receiving conditions for determining the first assignment range, wherein
the first assignment range is determined on the basis of the conditions.

[25]

The information processing method according to [24], in which the conditions include a condition related to spare calculation capacity of an entity to calculate the first assignment range.

[26]

The information processing method according to [24] or [25], in which the conditions include a condition related to communication quality between an entity to calculate the first assignment range and a predetermined entity.

[27]

The information processing method according to [26], in which the communication quality is calculated on the basis of at least one of a delay time, a data rate, and a channel occupancy ratio.

[28]

The information processing method according to any one of [24] to [27], in which an entity to execute the remaining calculation of the deep neural network and the calculation of the second assignment range and an entity to transmit the conditions for determining the first assignment range are different from each other.

[29]

An information processing device that executes an application using a deep neural network,
determines a first assignment range of a series of calculation of the deep neural network on the basis of conditions for determining the first assignment range, executes calculation of the first assignment range, and
transmits first information including identification information and an output value of a node included in a final layer in the first assignment range as a result of the calculation of the assignment range.

[30]

The information processing device according to [29], in which the information processing device transmits the first information to an entity that performs the series of calculation of the deep neural network next, and
a result of remaining calculation of the deep neural network or calculation of a second assignment range is received as a reply to the first information.

[31]

The information processing device according to [29] or [30], in which the conditions include a condition related to spare calculation capacity of the information processing device itself, and
the first assignment range is determined in accordance with the spare calculation capacity.

[32]

The information processing device according to any one of [29] to [31], in which the conditions include a condition related to communication quality between the information processing device itself and a predetermined entity, and
The first assignment range is determined in accordance with the communication quality.

[33]

The information processing device according to [32], in which the communication quality is calculated on the basis of at least one of a delay time, a data rate, and a channel occupancy ratio.

[34]

An information processing device that receives first information including identification information and an output value of a node included in a final layer in a first assignment range in a series of calculation of a deep neural network as a result of calculation of the first assignment range,
identifies a node to which the output value included in the first information is to be input on the basis of the identification information included in the first information, and
executes remaining calculation of the deep neural network or calculation of a second assignment range by inputting the output value included in the first information to the identified node.

[35]

The information processing device according to [34], in which a result of the remaining calculation of the deep neural network or the calculation of the second assignment range is sent as a reply to a transmission source of the result of the calculation of the first assignment range.

[36]

The information processing device according to [35], in which the second assignment range is determined on the basis of conditions for determining the second assignment range, and
the conditions include a condition related to spare calculation capacity of the information processing device itself.

[37]

The information processing device according to [35] or [36], in which the second assignment range is determined on the basis of conditions for determining the second assignment range, and
the conditions include a condition related to communication quality between the information processing device itself and a predetermined entity.

[38]

The information processing device according to [37], in which the communication quality is calculated on the basis of at least one of a delay time, a data rate, and a channel occupancy ratio.

### REFERENCE SIGNS LIST

1 Information processing system
11 Communication terminal (UE)
111 Wireless communication unit
1110 Transmission processing unit
1111 Coding unit
1112 Modulation unit
1113 Multiplexing unit
1114 Wireless transmission unit
1115 Reception processing unit
1116 Wireless reception unit
1117 Multiplexing separation unit
1118 Demodulation unit
1119 Decoding unit
112 Storage unit
113 Control unit
114 Arithmetic operation unit
1141 Condition setting unit
1142 Arithmetic operation model setting unit
1143 Arithmetic operation processing unit
115 Antenna
12 Cloud system
121 Cloud server
13 Communication network
131 Wireless communication node
132 Donor node
133 Core network
1331 Core network communication node
134 RAN
2 Dotted line frame (DNN)
21 DNN node
22 DNN link
50 Base station device
51 Wireless communication unit
510 Transmission processing unit
511 Coding unit
512 Modulation unit
513 Multiplexing unit
514 Wireless transmission unit
515 Reception processing unit
516 Wireless reception unit
517 Multiplexing separation unit
518 Demodulation unit
519 Decoding unit
52 Storage unit
53 Control unit
54 Arithmetic operation unit
55 Network communication unit
56 Antenna
601 AMF
602 NEF
603 NRF
604 NSSF
605 PCF
606 SMF
607 UDM
608 AF
609 AUSF
610 UCMF
630 UPF
640 DN

1. An information processing device that receives information regarding resources of a communication network that relays communication between a communication terminal that transmits an input to a deep neural network or is in charge of at least a part of a series of calculation of the deep neural network and transmits a result of the calculation and a server that is able to be in charge of at least a part of the series of calculation, and
determines an entity to which the series of calculation is assigned from among the communication terminal, the server, and communication nodes in the communication network on the basis of the information regarding the resources.

2. The information processing device according to claim 1, wherein at least one of the communication nodes is determined as the entity to which the series of calculation is assigned.

3. The information processing device according to claim 1, wherein a calculation range of which the entity with the series of calculation assigned thereto is in charge is determined on the basis of the information regarding the resources.

4. The information processing device according to claim 2, wherein at least one of the communication nodes that are present on a communication route between the communication terminal and the server is determined as the entity to which the series of calculation is assigned.

5. The information processing device according to claim 2,
wherein the resources include communication capacity or communication quality of a communication link in the communication network, and
at least one of the communication nodes is determined as the entity to which the series of calculation is assigned on the basis of the communication capacity or the communication quality.

6. The information processing device according to claim 5, wherein a communication time in which the result of the calculation performed by the communication node is transmitted via the communication link is estimated on the basis of the communication capacity or the communication quality, and at least one of the communication nodes is determined as the entity to which the series of calculation is assigned on the basis of the communication time.

7. The information processing device according to claim 2,
wherein the resources include spare calculation capacity of the communication nodes, and
at least one of the communication nodes is determined as the entity to which the series of calculation is assigned on the basis of the spare calculation capacity of the communication nodes.

8. The information processing device according to claim 7, wherein calculation times required by the communication nodes to perform the calculation are estimated on the basis of the spare calculation capacity of the communication nodes, and at least one of the communication nodes is determined as an entity to which the series of calculation is assigned on the basis of the calculation times.

9. The information processing device according to claim 2,
wherein the resources include communication capacity or communication quality of a communication link in the communication network and spare calculation capacity of the communication nodes,
communication times in which the result of the calculation performed by the communication nodes are transmitted via the communication link are estimated on the basis of the communication capacity or the communication quality,
calculation times required by the communication nodes to perform calculation are estimated on the basis of the spare calculation capacity of the communication nodes, and
at least one of the communication nodes is determined as the entity to which the series of calculation is assigned on the basis of a condition that a sum of the communication time and the calculation time does not exceed a predetermined threshold value.

10. The information processing device according to claim 4,
wherein the information processing device further receives information regarding a position of the communication terminal, and
the entity to which the series of calculation is assigned is changed in response to a change in the communication route accompanying movement of the communication terminal.

11. The information processing device according to claim 4,
wherein the information processing device further receives information regarding a topology of the communication network, and
the entity to which the series of calculation is assigned is changed in response to a change in the communication route accompanying a change in the topology.

12. The information processing device according to claim 3, wherein the calculation range of which the entity with the series of calculation assigned thereto is in charge is determined by selecting one of a plurality of splitting modes on the basis of the resources.

13. The information processing device according to claim 12,
wherein the resources include a position of the communication terminal, and
the splitting modes are recreated when no predetermined communication nodes are present on the communication route changed with movement of the communication terminal.

14. The information processing device according to claim 3, wherein the calculation range of which the entity with the series of calculation assigned thereto is in charge is changed by increasing or decreasing the calculation range of which the entity with the series of calculation assigned thereto is in charge on the basis of variations in the resources.

15. The information processing device according to claim 3, wherein the calculation range is transmitted to the communication node determined as the entity to which the series of calculation is assigned.

16. The information processing device according to claim 15,
wherein a setting value for improving quality of a wireless communication link on the communication route is determined, and
the setting value for improving the quality of the wireless communication link on the communication route is transmitted to the communication nodes that are present on the communication route.

17. An information processing device that receives a part of a series of calculation based on a deep neural network as an assigned calculation range,
performs calculation of the calculation range,
transmits a calculation result of the calculation range to a designated destination,
acquires information regarding spare calculation capacity or communication capacity or communication quality of a communication link through which the calculation result is transmitted,
transmits the acquired information to a designation source of the calculation range, and
receives information regarding a change in the calculation range from the designation source.

18. The information processing device according to claim 17, wherein the information regarding the change in the calculation range is information indicating one of a plurality of splitting modes.

19. The information processing device according to claim 17, wherein, in a case where the calculation result satisfies a condition for ending the series of calculation in the middle, the calculation result is transmitted to a final reception destination of the calculation result of the series of calculation rather than the designated destination.

20. An information processing method comprising the steps of:
receiving information regarding resources of a communication network that relays communication between a communication terminal that transmits an input to a deep neural network or is in charge of at least a part of a series of calculation of the deep neural network and transmits a result of the calculation and a server that is able to be in charge of at least a part of the series of calculation; and
determining a plurality of entities to which the series of calculation is assigned from among the communication terminal, the server, and communication nodes in the communication network on the basis of the information regarding the resources.

21. An information processing system comprising:
a plurality of communication nodes that belong to a communication network that relays communication between a communication terminal that transmits an input to a deep neural network or is in charge of at least a part of a series of calculation of the deep neural network and transmits a result of the calculation and a server that is able to be in charge of at least a part of the series of calculation,
wherein the plurality of communication nodes transmit information regarding resources of the communication network to a predetermined communication node from among the plurality of communication nodes, and
the predetermined communication node receives the information regarding the resources, and
determines a plurality of entities to which the series of calculation is assigned from among the communication terminal, the server, and the communication nodes on the basis of the information regarding the resources.

22. An information processing method comprising the steps of:
determining a first assignment range of a series of calculation of a deep neural network;
executing calculation of the first assignment range;
transmitting first information including identification information and an output value of a node included in a final layer in the first assignment range as a result of the calculation of the first assignment range;
receiving the first information;
identifying a node to which the output value included in the first information is to be input on the basis of the identification information included in the first information; and
executing remaining calculation of the deep neural network or calculation of a second assignment range by inputting the output value included in the first information to the identified node.

23. The information processing method according to claim 22, further comprising the step of:
replying with a result of the remaining calculation of the deep neural network or the calculation of the second assignment range to a transmission source of the result of the calculation of the first assignment range.

24. The information processing method according to claim 22, further comprising the step of:
receiving conditions for determining the first assignment range, wherein
the first assignment range is determined on the basis of the conditions.

25. The information processing method according to claim 24, wherein the conditions include a condition related to spare calculation capacity of an entity to calculate the first assignment range.

26. The information processing method according to claim 24, wherein the conditions include a condition related to communication quality between an entity to calculate the first assignment range and a predetermined entity.

27. The information processing method according to claim 26, wherein the communication quality is calculated on the basis of at least one of a delay time, a data rate, and a channel occupancy ratio.

28. The information processing method according to claim 24, wherein an entity to execute the remaining calculation of the deep neural network and the calculation of the second assignment range and an entity to transmit the conditions for determining the first assignment range are different from each other.

29. An information processing device that executes an application using a deep neural network,
determines a first assignment range of a series of calculation of the deep neural network on the basis of conditions for determining the first assignment range, executes calculation of the first assignment range, and
transmits first information including identification information and an output value of a node included in a final layer in the first assignment range as a result of the calculation of the first assignment range.

30. The information processing device according to claim 29, wherein the information processing device transmits the first information to an entity that performs the series of calculation of the deep neural network next, and
a result of remaining calculation of the deep neural network or calculation of a second assignment range is received as a reply to the first information.

31. The information processing device according to claim 29,
wherein the conditions include a condition related to spare calculation capacity of the information processing device itself, and
the first assignment range is determined in accordance with the spare calculation capacity.

32. The information processing device according to claim 29,
wherein the conditions include a condition related to communication quality between the information processing device itself and a predetermined entity and the first assignment range is determined in accordance with the communication quality.

33. The information processing device according to claim 32, wherein the communication quality is calculated on the basis of at least one of a delay time, a data rate, and a channel occupancy ratio.

34. An information processing device that receives first information including identification information and an output value of a node included in a final layer in a first assignment range in a series of calculation of a deep neural network as a result of calculation of the first assignment range,
identifies a node to which the output value included in the first information is to be input on the basis of the identification information included in the first information, and
executes remaining calculation of the deep neural network or calculation of a second assignment range by inputting the output value included in the first information to the identified node.

35. The information processing device according to claim 34, wherein a result of the remaining calculation of the deep neural network or the calculation of the second assignment range is sent as a reply to a transmission source of the result of the calculation of the first assignment range.

36. The information processing device according to claim 35,
wherein the second assignment range is determined on the basis of conditions for determining the second assignment range, and
the conditions include a condition related to spare calculation capacity of the information processing device itself.

37. The information processing device according to claim 35,
wherein the second assignment range is determined on the basis of conditions for determining the second assignment range, and
the conditions include a condition related to communication quality between the information processing device itself and a predetermined entity.

38. The information processing device according to claim 37, wherein the communication quality is calculated on the basis of at least one of a delay time, a data rate, and a channel occupancy ratio.
